(19) United States
(12) Patent Application Publication
(10) Pub. No.: US 2025/0374291 A1
(43) Pub. Date: Dec. 4, 2025

(54) METHOD FOR NETWORK CONTROLLED REPEATER, METHOD FOR ACCESS NETWORK NODE, NETWORK CONTROLLED REPEATER, AND ACCESS NETWORK NODE

(71) Applicant: NEC Corporation, Minato-ku, Tokyo (JP)

(72) Inventors: Pravjyot DEOGUN, Milton Keynes (GB); Yuhua CHEN, London (GB); Robert ARNOTT, London (GB)

(73) Assignee: NEC Corporation, Minato-ku, Tokyo (JP)

(21) Appl. No.: 18/876,899

(22) PCT Filed: Aug. 17, 2023
(86) PCT No.: PCT/JP2023/029683

§ 371 Date: Dec. 19, 2024

(30) Foreign Application Priority Data
Aug. 31, 2022 (GB) 2212692.4

(51) Int. Cl. H04W 72/231; H04B 7/06; H04L 5/00; H04W 72/0446

(52) U.S. Cl. CPC H04W 72/231; H04B 7/06968; H04L 5/0051; H04W 72/0446

(57) ABSTRACT

A method for a network controlled repeater (NCR) is disclosed. The NCR has a control link and a backhaul link, to an access network node, and an access link to a user equipment, UE. Transmission via the control link is terminated at the NCR and transmission via the backhaul link is forwarded via the NCR to the access link. The method includes: transmitting, to the access network node, capability information indicating capability for dealing with interference among transmission of the control link, the backhaul link, and the access link; and receiving, from the access network node via the control link, control information for controlling the NCR to deal with the interference based on the capability information.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements related to network controlled repeaters (NCR).

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN)/radio access technology (RAT) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

In a communication network a UE may fall outside of a transmission range of a base station. However, a repeater may be provided that receives transmissions from the base station and retransmits the received signals to effectively extend the range of the base station. The UE is therefore able to communicate with the base station via the repeater. The repeater provides a flexible alternative to extending the coverage of the network without deploying additional regular full-stack cells. The repeater may be referred to as a radio frequency repeater (RF repeater). A simple repeater may receive a signal from the base station and simply broadcast the received signal omnidirectionally. In other words, a RF repeater may simply amplify and forward signals it receives from the base station, so as to provide an area of extended coverage.

Whilst RF repeaters provide a relatively cost-effective method of extending network coverage, simple amplification and forwarding may not always be suitable, for example when the original transmission from the base station is a beamformed transmission. In order to inform the repeater of configuration information for transmitting and/or receiving signals, the repeater may receive control information from the base station. Such repeaters may be referred to as ‘network controlled repeaters’ (NCR), and the control information received from the base station may be referred to as ‘side control information’.

However, there is a need for improved communication between the NCR and the gNB, and between the NCR and UEs, to facilitate improved integration of the NCR in the network and improved control of the NCR by the gNB. For example, there is a need for improved apparatus and methods for more efficient transmission and reception at the NCR, improved power management at the NCR, improved frequency management and beamforming, and reduced interference.

### CITATION LIST

### Non Patent Literature

NPL 1: ‘NGMN 5G White Paper’ V1.0

### SUMMARY OF INVENTION

### Technical Problem

The present disclosure seeks to provide methods and associated apparatus that address or at least alleviate (at least some of) the above-described issues.

### Solution to Problem

According to one aspect, a method for a network controlled repeater, NCR, is provided, the NCR having a control link and a backhaul link, to an access network node, and an access link to a user equipment, UE, and transmission via the control link being terminated at the NCR and transmission via the backhaul link being forwarded via the NCR to the access link, the method comprising: transmitting, to the access network node, capability information indicating capability for dealing with interference among transmission of the control link, the backhaul link, and the access link; and receiving, from the access network node via the control link, control information for controlling the NCR to deal with the interference based on the capability information.

Optionally, the capability information may indicate a capability of power and/or gain control of transmission of the backhaul link and/or the access link, and the capability information may include at least one of: a range of gain or power values supported by the NCR; or a maximum gain or power value supported by the NCR.

Optionally, the capability information may indicate a capability of power and/or gain control of transmission of the backhaul link and/or the access link, and the capability information may include a currently power or gain of transmission of the backhaul link and/or the access link at the NCR.

Optionally or instead, the capability of power and/or gain control of transmission of the backhaul link and/or the access link may include: information applied to an uplink transmission and information applied to a downlink transmission, or information applied to both an uplink transmission and a downlink transmission.

Optionally or instead, the capability information may indicate a capability of power and/or gain control of transmission of the backhaul link and/or the access link, and the capability information may include at least one of: an indication of whether the NCR supports power control or gain control for transmission of the access link; or an indication of whether the NCR supports power control or gain control for transmission of the backhaul link.

Optionally or instead, in a case where a capability of power and/or gain control of transmission of the backhaul link and/or the access link is not supported by the NCR, the capability information may include a fixed gain value or power value that indicates that the capability of power and/or gain control of transmission of the backhaul link and/or the access link is not supported.

Optionally or instead, the capability information may include at least one of: an indication of a power or gain increase; or an indication of a power or gain decrease.

Optionally or instead, the method may further comprise transmitting the capability information to the access network node based on a timer, or in response to a transmission received from the access network node.

Optionally or instead, the capability information may indicate a capability of frequency information supported by the NCR, and the capability information may include at least one of: an indication of a frequency or frequency range supported by the NCR for the access link; or an indication of a frequency or frequency range supported by the NCR for the backhaul link, and the capability information may be independent from a capability of a frequency or frequency range supported by the NCR for the control link.

Optionally, the frequency or frequency range supported by the NCR for the control link may be different from the frequency or frequency range supported by the NCR for the access link or the frequency or frequency range supported by the NCR for the backhaul link.

Optionally or instead, the capability information may include an indication of: a first frequency or frequency range that is supported by the NCR, for one of the access link and the backhaul link with a first time division duplex, TDD, configuration; and a second frequency or frequency range that is supported by the NCR, for another one of the access link and the backhaul link, with a second TDD configuration, and the first TDD configuration may be different from the second TDD configuration.

Optionally or instead, the capability information may include an indication of a bandwidth corresponding to the frequency or frequency range supported by the NCR for the access link or the backhaul link, and a bandwidth corresponding to the frequency or frequency range supported by the NCR for the control link may be restricted by the capability of the frequency or frequency range supported by the NCR for the control link.

Optionally or instead, the capability information may include a capability of beamforming of the NCR, and the capability information may include an indication of an antenna configuration or a beam configuration supported by the NCR for transmission of a beamformed signal.

Optionally, the capability information may include an indication of at least one of: horizontal or vertical antenna elements or ports supported by the NCR for transmission of a beamformed signal; a panel supported by the NCR for transmission of a beamformed signal; or a port supported by the NCR for transmission of a beamformed signal.

Optionally or instead, the indication of the antenna configuration or the beam configuration supported by the NCR may indicate an antenna configuration or a beam configuration supported by the NCR for the access link.

Optionally or instead, the capability information may include an indication of a number of beam configurations supported by the NCR.

Optionally or instead, the capability information may include an indication of a number of beams of a first beam type supported by the NCR, and an indication of a number of beams of a second beam type supported by the NCR.

Optionally, the first beam type may correspond to a wide beam and the second beam type corresponds to a narrow beam; or the first beam type may correspond to a Synchronization Signal/Physical Broadcast Channel, PBCH, Block, SSB, beam and the second beam type corresponds to a Channel State Information Reference Signal, CSI-RS, beam or a data beam.

Optionally or instead, the capability information may include an indication of a beam width of a beam supported by the NCR and/or an indication of a beam sweeping range.

Optionally or instead, the capability information may include an indication of at least one beam direction value supported by the NCR.

Optionally or instead, the capability information may include an indication of a first beamforming capability of the NCR supported for a first frequency band, and an indication of a second beamforming capability of the NCR supported for a second frequency band.

Optionally or instead, the capability information may indicate a capability of the NCR to perform simultaneous uplink or downlink communication for: the control link, and the backhaul link or the access link, at a same symbol.

Optionally, the capability information may indicate the capability of the NCR to perform simultaneous uplink or downlink communication for a particular frequency band or carrier.

Optionally or instead, the capability information may indicate the capability of the NCR to perform: simultaneous uplink or downlink communication for the control link for a first frequency band, and simultaneous uplink or downlink communication for the backhaul link or the access link for a second frequency band different from the first frequency band.

Optionally or instead, the capability information may indicate the NCR cannot perform simultaneous uplink or downlink communication due to conflict among the control link and backhaul link or the access link, and the method may further comprise stopping transmission via the access link and/or the backhaul link.

Optionally or instead, the method may further comprise receiving, from the access network node, an indication of a mapping between a port or symbol corresponding to a reference signal received from the access network node and a corresponding antenna element or port of the NCR; and transmitting the reference signal based on the mapping.

Optionally or instead, the method may further comprise receiving, from the access network node, an indication of a mapping between a port corresponding to a reference signal received from the access network node and a corresponding time occasion; and transmitting the reference signal based on the mapping.

Optionally or instead, the method may further comprise receiving, from the access network node, an indication of a mapping between a time domain resource corresponding to a reference signal received from the access network node and a corresponding antenna element or port of the NCR; and transmitting the reference signal based on the mapping.

Optionally or instead, the method may further comprise receiving, from the access network node, a beam indication that indicates a beam to be used for data transmission via the access link.

Optionally or instead, the beam indication may include one or more weight values to be used for an antenna port or antenna element of the NCR to be used for the data transmission via the access link.

Optionally, the capability information may indicate information for a plurality of beams which are overlapping in spatial domain and information transmission/reception direction for each of the plurality of the beams, and the method may comprise: the beam indication that indicates one of the plurality of the beams, to be used for the data transmission via the access link.

According to another aspect, a method for a network controlled repeater, NCR, is disclosed, the method comprising: receiving, from an access network node, downlink control information for controlling transmission or reception at the NCR, and determining to transmit Hybrid Automatic Repeat Request, HARQ, feedback that indicates whether the downlink control information has been received successfully at the NCR.

Optionally, the determining may include at least one of: determining based on whether the downlink control information indicates to not perform any transmission via a backhaul link between the NCR and the access network node and/or an access link between the access network node and a user equipment, UE, determining based on whether the downlink control information indicates to modify configuration for transmission via the backhaul link and/or the access link, determining based on an indication, transmitted from the access network node, indicating whether transmission of the HARQ feedback is to be enabled or disabled, determining based on time difference between time occasion indicated by the downlink control information and an occasion for the HARQ feedback, or determining based on time difference between timing of receiving the downlink control information and the time occasion indicated by the downlink control information.

Optionally or instead, the downlink control information may indicate a time occasion for which the NCR behaviour should change, and a time occasion for which the NCR behavior should not change.

According to another aspect, a method for an access network node is disclosed, the method comprising: receiving, from a network controlled repeater, NCR, having a control link and a backhaul link, to an access network node, and an access link to a user equipment, UE, and transmission via the control link being terminated at the NCR and transmission via the backhaul link being forwarded via the NCR to the access link, capability information indicating capability for dealing with interference among transmission of the control link, the backhaul link, and the access link; and transmitting, to the NCR via the control link, control information for controlling the NCR to deal with the interference based on the capability information.

According to another aspect, a method for an access network node is disclosed, the method comprising: transmitting, to a network controlled repeater, NCR, downlink control information for controlling transmission or reception at the NCR, and determining to receive Hybrid Automatic Repeat Request, HARQ, feedback that indicates whether the downlink control information has been received successfully at the NCR.

According to another aspect, a network controlled repeater, NCR, is disclosed, the NCR having a control link and a backhaul link, to an access network node, and an access link to a user equipment, UE, and transmission via the control link being terminated at the NCR and transmission via the backhaul link being forwarded via the NCR to the access link, the NCR comprising: means for transmitting, to an access network node, capability information indicating capability for dealing with interference among transmission of the control link, the backhaul link, and the access link; and means for receiving, from the access network node, control information for controlling the NCR to deal with the interference based on the capability information.

According to another aspect, a network controlled repeater, NCR, is disclosed, the NCR comprising: means for receiving, from an access network node, downlink control information for controlling transmission or reception at the NCR, and means for determining to transmit Hybrid Automatic Repeat Request, HARQ, feedback that indicates whether the downlink control information has been received successfully at the NCR.

According to another aspect, an access network node is disclosed, the access network node comprising: means for receiving, from a network controlled repeater, NCR, having a control link and a backhaul link, to an access network node, and an access link to a user equipment, UE, and transmission via the control link being terminated at the NCR and transmission via the backhaul link being forwarded via the NCR to the access link, capability information indicating capability for dealing with interference among transmission of the control link, the backhaul link, and the access link; and means for transmitting, to the NCR via the control link, control information for controlling the NCR to deal with the interference based on the capability information.

According to another aspect, an access network node is disclosed, the access network node comprising: means for transmitting, to a network controlled repeater, NCR, downlink control information for controlling transmission or reception at the NCR, and means for determining to receive Hybrid Automatic Repeat Request, HARQ, feedback that indicates whether the downlink control information has been received successfully at the NCR.

### BRIEF DESCRIPTION OF DRAWINGS

Example embodiments of the disclosure will now be described, by way of example, with reference to the accompanying drawings.

FIG. 1 illustrates schematically a mobile (cellular or wireless) telecommunication system to which example embodiments of the disclosure may be applied.

FIG. 2 shows a schematic diagram of a network-controlled repeater (NCR) arranged between a base station and a UE.

FIG. 3 is a schematic block diagram of a mobile device.

FIG. 4 is a schematic block diagram of a base station.

FIG. 5 a schematic block diagram of an NCR.

FIG. 6 shows an example of communication between the (R)AN node and the UE via the NCR.

FIG. 7 shows a schematic flow diagram illustrating an NCR procedure.

FIG. 8A shows an NCR-MT initial access procedure.

FIG. 8B shows an NCR-MT initial access procedure.

FIG. 9 shows an NCR-Fwd setup procedure.

FIG. 10 shows an alternative NCR-Fwd setup procedure.

FIG. 11A shows a side control information update procedure.

FIG. 11B shows a side control information update procedure.

FIG. 12 shows a transmission of power control capability information.

FIG. 13 shows a transmission of supported frequency information.

FIG. 14 shows a transmission of beamforming capability information.

FIG. 15 shows a further example of communication between the (R)AN node, the NCR and a UE.

FIG. 16 shows an example of beamforming for a transmission between the NCR and a UE.

FIG. 17 shows an example of a DCI indication and HARQ feedback exchanged between the NCR and (R)AN node.

FIG. 18 shows an example of interference between the control link and the access link.

FIG. 19 shows a transmission of uplink conflict information.

### DESCRIPTION OF EXAMPLE EMBODIMENTS

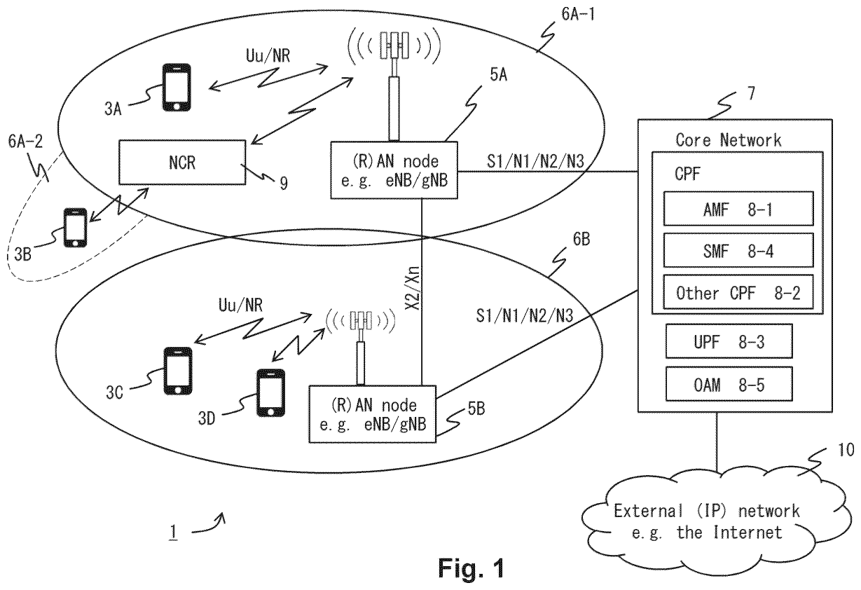

FIG. 1 illustrates schematically a mobile (cellular or wireless) telecommunication system 1 to which example embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA), a 5G RAT, and/or later generation Radio Access Technologies. It will be appreciated that a number of base stations 5 form a (radio) access network or (R)AN. As those skilled in the art will appreciate, whilst four mobile devices 3A, 3B, 3C and 3D and two base stations 5A and 5B are shown in FIG. 1 for illustration purposes, the system, when implemented, will typically include other base stations/(R)AN nodes 5 and mobile devices (UEs) 3.

Each base station 5 controls one or more associated cells 6 (either directly or via other nodes such as home base stations, relays, remote radio heads, distributed units, and/or the like). In this example, a base station 5a has an area of direct coverage 6A-1 and a further area of coverage 6A-2 provided by a network controlled repeater (NCR) 9. The UE 3B in the further area of coverage 6A-2 provided by the NCR 9 is able to communicate with the base station 5a via the NCR 9.

A base station 5 that supports Next Generation/5G protocols may be referred to as a ‘gNB’. It will be appreciated that some base stations 5 may be configured to support both 4G and 5G, and/or any other 3GPP or non-3GPP communication protocols. It will be appreciated that a number of base stations 5 form a (radio) access network or (R)AN.

The mobile device 3 and its serving base station 5 are connected via an appropriate air interface (for example the so-called ‘NR’ air interface, the ‘Uu’ interface, and/or the like). Neighbouring base stations 5 may be connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs) 8-3. The one or more control plane functions (CPFs) include a control plane function 8-1 that is responsible for handling connection and mobility tasks for the mobile devices 3, such as the so-called Access and Mobility Management Function (AMF) in 5G, or the Mobility Management Entity (MME) in 4G. The one or more control plane functions (CPFs) also include a control plane function that is 8-4 that is responsible for handling communication sessions for the mobile devices 3 such as session establishment, modification and release (such as the Session Management Function (SMF)), and may also include one or more additional control plane functions 8-2. The Operations, Administration and Maintenance (OAM) function 8-5 may be implemented in software in one or more 5G CN nodes. The core network 7 is coupled to a data network 10, such as the Internet or a similar Internet Protocol (IP) based network.

When the UE 3 initially establishes a radio resource control (RRC) connection with a base station 5 via a cell it registers with an appropriate core network node 8-1 (e.g, AMF, MME). The UE 3 is in the so-called RRC connected state and an associated UE context is maintained by the network. When the UE 3 is in the so-called RRC idle or in the RRC inactive state, it selects an appropriate cell for camping so that the network is aware of the approximate location of the UE 3 (although not necessarily on a cell level).

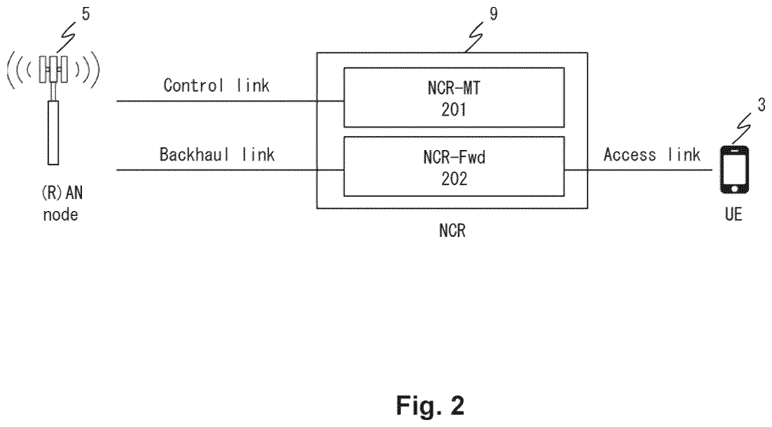

FIG. 2 shows a schematic diagram of the NCR 9 arranged between the base station 5 and the UE 3. The NCR 9 comprises an ‘NCR-Mobile termination’ (NCR-MT) 201 for communication with the base station 5 via a control link (including the reception of ‘side control information’, described in more detail below). The control link (C-link) is based on the new radio (NR) Uu interface. The NCR 9 also comprises an ‘NCR-Forwarding’ (NCR-Fwd) 202 for communication with the base station 5 via a backhaul link, and for communication with the UE 3 via an access link.

The NCR 9 receives control information from the base station 5 (e.g. gNB). This control information may be referred to as ‘side control information’. The side control information may include control information for downlink (DL) and/or uplink (UL) transmissions. The behaviour of the NCR-Fwd 202 (e.g. one or more configurations of the NCR 9 related to the backhaul link and/or the access link) is controlled based on the control information received from the base station 5.

For DL transmissions, the repeater 9 receives transmissions from the base station 5 via the backhaul link, and transmits corresponding signals to the UE 3 via the access link. As described in more detail later, the side control information may control the direction (beamforming), timing, frequencies, and power of the transmissions on the access link to the UE 3. In other words, the side control information controls the forwarding of transmissions from the base station 5 to the UE 3 by the NCR 9. The side control information may also indicate, for example, a time or frequency related to a signal that is to be received at the NCR 9 from the base station 5 via the backhaul. For UL transmissions, the NCR 9 receives transmissions from the UE 3 over the access link and transmits corresponding signals to the base station 5. The side control information may control the direction on which the NCR 9 receives on the access link in a particular time and/or frequency resource window. The side control information may also indicate a time at which to receive a signal from the UE 3 via the access link.

For downlink signal forwarding, the side control information may comprise information indicating a direction in which the NCR 9 is to transmit the downlink signal to the UE 3 at a particular time (e.g. time window) via the access link. For uplink signal forwarding, the side control information may comprise information indicating a direction in which the NCR 9 is to receive the uplink signal from the UE 3 at a particular time (e.g. time window). The side control information may indicate different directions to be used at different times for uplink/downlink reception/transmission. The side control information may comprise information for a beam refinement procedure for a beam transmitted by the NCR 9. A beam refinement procedure may be used, for example, when the conditions of a radio link between the UE 3 and the NCR 9 change.

The side control information may comprise access link configuration information indicating a configuration for transmission and/or reception via the access link. The side control information may also (or instead) comprise backhaul link configuration information, or control link configuration information, indicating a configuration for transmission and/or reception via the backhaul link or control link, respectively.

The side control information may include configuration information for transmitting the beamformed signals and/or uplink/downlink (UL/DL) time division duplex (TDD) configuration information. The UL/DL TDD configuration information may indicate a semi-static TDD UL/DL configuration for the control link, backhaul link and/or the access link. The same TDD UL/DL configuration may be assumed for the backhaul link and the access link. The same TDD UL/DL configuration may be assumed for the control link, backhaul link and access link if the NCR-MT and the NCR-Fwd are in the same frequency band. More generally, the control information is used for controlling the forwarding behaviour, for UL and/or DL, of the NCR 9.

For the access link, the base station 5 may transmit a dynamic beam indication, a semi-static beam indication, or a combination of a dynamic beam indication and a semi-static beam indication to the NCR 9.

The side control information may comprise information related to a semi-static and/or dynamic downlink/uplink configuration, adaptive transmitter/receiver spatial beamforming, ON-OFF information (e.g. for more efficient interference management and improved energy efficiency), power control information (e.g. for improved interference management, which may be achieved, for example, by controlling the amplification gain of the NCR-Fwd 202), or any other suitable control information. The ON-OFF information may be for controlling the behaviour of the NCR-Fwd 202, and may include an explicit indication of an ON-OFF state (e.g. via dynamic signalling or semi-static signalling) or an ON-OFF pattern (e.g. a periodic/semi-static ON-OFF pattern or a new discontinuous reception (DRX)-like pattern for ON-OFF). The ON-OFF information may comprise an implicit indication via signalling for other information such as beam information, DL/UL configuration information, or power control information. The ON-OFF information may comprise a combination of an explicit indication and an implicit indication.

The side control information may comprise timing information to indicate when the NCR 9 is to amplify and forward signals for downlink and/or uplink. The timing information may be for configuring the DL receiving timing of the NCR-Fwd for the backhaul link. The timing information may also, or alternatively, be for configuring the UL receiving timing of the NCR-Fwd for the access link. The NCR-Fwd 202 amplifies and forwards the corresponding received signal to UE 3 in the downlink case, or to the base station 5 in uplink case.

The side control information may be transmitted from the base station 5 to the NCR 9 as L1/L2 control signalling and/or as RRC signalling. The NCR 9 may obtain configuration information for receiving the L1/L2 signalling via radio resource control (RRC) signalling. Alternatively, the configuration information for receiving the L1/L2 signalling may be received from an operations administration and maintenance (OAM) entity 8-5 in the network, or may be preconfigured at the NCR 9. In a further alternative, the configuration information for receiving the L1/L2 signalling may be partially received via RRC signalling and partially received from the OAM entity in the network. The configuration information for receiving the L1/L2 signalling may comprise configuration information for receiving physical downlink control channel (PDCCH) and/or physical downlink shared channel (PDSCH), configuration information for transmitting physical uplink control channel (PUCCH), configuration information for transmitting physical uplink shared channel (PUSCH), configuration information for downlink control information (DCI), configuration information for uplink control information (UCI), and/or configuration information for medium access control control-element (MAC CE).

Either fixed beams or adaptive beams may be used for the control link and the backhaul link between the NCR 9 and the base station 5.

The DL of the control link and the backhaul link may be performed simultaneously, or in a time division multiplexed (TDM) manner, for example based on timing information included in the side control information. The UL of the control link and the UL of the backhaul link may be performed in a TDM manner.

The same Transmission Configuration Index (TCI) states used for the control link may be assumed for a beam for the NCR-Fwd 202 if the carriers of the NCR-MT 201 are within the set of carriers forwarded by the NCR-Fwd 202.

### User Equipment (UE)

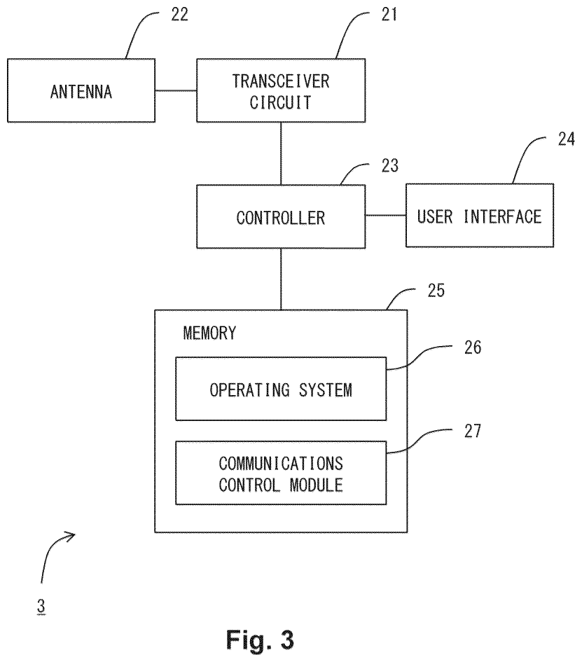

FIG. 3 is a block diagram illustrating the main components of the mobile device (UE) 3 shown in FIG. 1. As shown, the UE 3 includes a transceiver circuit 21 which is operable to transmit signals to and to receive signals from one or more connected nodes via one or more antenna 22. Although not necessarily shown in FIG. 3, the UE 3 will of course have all the usual functionality of a conventional mobile device (such as a user interface 24) and this may be provided by any one or any combination of hardware, software and firmware, as appropriate. A controller 23 controls the operation of the UE 3 in accordance with software stored in a memory 25. The software may be pre-installed in the memory 25 and/or may be downloaded via the telecommunication network or from a removable data storage device (RMD), for example. The software includes, among other things, an operating system 26, a communications control module 27.

The communications control module 27 is responsible for handling (generating/sending/receiving) signalling and uplink/downlink data packets between the UE 3 and other nodes, including (R)AN nodes 6, the NCR 9, and core network nodes. The signalling may comprise control signalling (such as RRC signalling) related to configuring and assisting cell reselection by the UE 3.

The UE 3 may receive one or more signals from the base station 5 or the NCR 9 (e.g. a beamformed signal transmitted by the NCR 9) and may perform corresponding signal strength measurements. The UE 3 may determine, for example, to communicate using a particular beam transmitted by the NCR 9 (e.g. the beam having the strongest signal received at the UE 3 during a measurement period). Alternatively, the UE 3 may report the signal strength measurement (or any other suitable measured/determined parameter related to the signal strength or signal quality) to the base station 5, and the base station 5 may select the beam to be used for communication. The beam selected by the UE 3 (or selected by the base station 5) can be identified using a corresponding index and used for communication, either directly between the base station 5 and the UE 3, or via the NCR 9.

### Base Station/Gateway (Access Network Node)

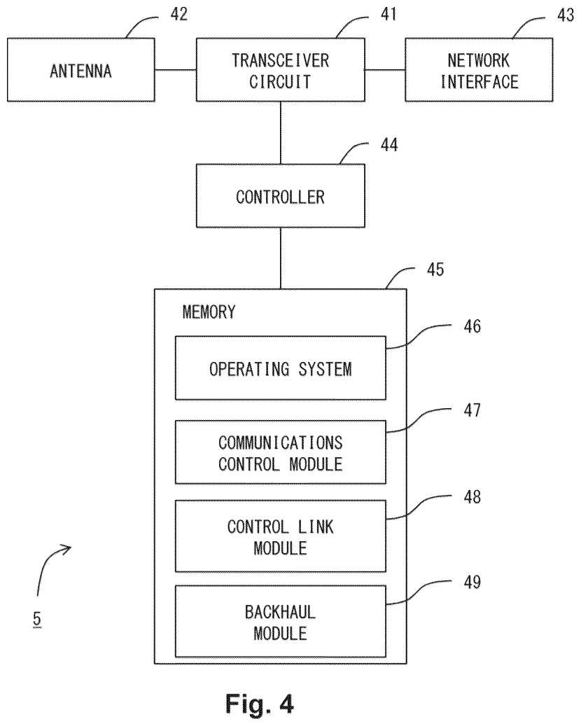

FIG. 4 is a block diagram illustrating the main components of the gateway/base station 5 shown in FIG. 1 (a base station (gNB) or a similar access network node; the base station need not necessarily be a gNB). As shown, the base station 5 includes a transceiver circuit 41 which is operable to transmit signals to and to receive signals from one or more UEs 3 or the NCR 9 via one or more antenna 42, and to transmit signals to and to receive signals from other network nodes (either directly or indirectly) via a network interface 43. The network interface 43 typically includes an appropriate base station-base station interface (such as X2/Xn) and an appropriate base station-core network interface (such as S1/NG-C/NG-U). A controller 44 controls the operation of the base station 5 in accordance with software stored in a memory 45. The software may be pre-installed in the memory 45 and/or may be downloaded via the network or from a removable data storage device (RMD), for example. The software includes, among other things, an operating system 46, a communications control module 47, a control link module 48 and a backhaul module 49.

The communications control module 47 is responsible for handling (generating/sending/receiving) signalling between the base station 5 and other nodes, such as the UE 3 and core network nodes. The signalling may comprise, for example, control signalling (such as RRC signalling) related to configuring and assisting cell reselection by the UE 3.

The control link module 48 is responsible for controlling communication via the control link with the NCR-MT 201 of the NCR 9. It will be appreciated that the control link module 48 may be configured to control the communication over the control link according to any of the examples described below.

The backhaul module 49 is responsible for controlling communication via the backhaul with the NCR-Fwd 202 of the NCR 9. It will be appreciated that the backhaul module 49 may be configured to control the communication over the backhaul according to any of the examples described below.

### Network Controlled Repeater (NCR)

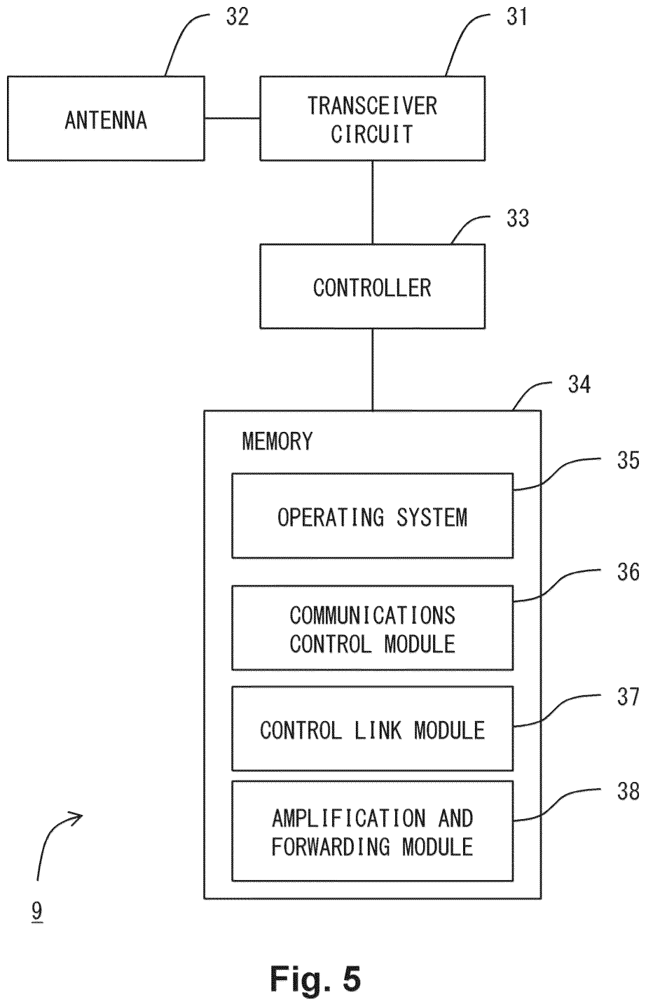

FIG. 5 is a block diagram illustrating the main components of the NCR 9 shown in FIG. 1. As shown, the NCR 9 includes a transceiver circuit 31 which is operable to transmit signals to and to receive signals from one or more UEs 3 and the base station 5 via one or more antenna 42. A controller 33 controls the operation of the NCR 9 in accordance with software stored in a memory 34. The software may be pre-installed in the memory 34 and/or may be downloaded via the network or from a removable data storage device (RMD), for example. The software includes, among other things, an operating system 35, a communications control module 36, a control link module 37 and an amplification and forwarding module 38.

The communications control module 36 is responsible for overall handling (generating/sending/receiving) of transmissions to/from the base station 5 and to/from the UE 3.

The control link module 37 is responsible for controlling communication via the control link with the base station 5. It will be appreciated that the control link module 37 may be configured to control the communication over the control link according to any of the examples described below. The control link module 37 may be the NCR-MT 201 illustrated in FIG. 2.

The amplification and forwarding module 38 is responsible for controlling communication with the base station 5 via the backhaul, and for controlling communication with the UE 3 via the access link. It will be appreciated that the amplification and forwarding module 38 may be configured to control the communication over the backhaul and the access link according to any of the examples described below. The amplification and forwarding module 38 may be the NCR-Fwd 202 illustrated in FIG. 2.

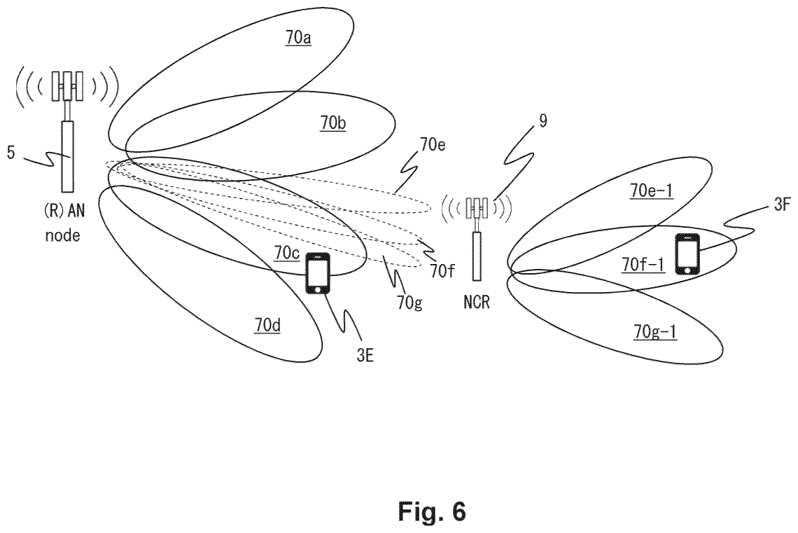

A received signal (e.g. a broadcast signal) may be relayed over the access link multiple times by the NCR 9, but in different beam directions, thereby achieving a ‘beam sweeping’ effect (illustrated in FIG. 6).

The NCR 9 may be transparent to the UEs 3 in the system 1. The NCR 9 may be configured to maintain the Base station-repeater link (the backhaul link and/or the control link) and the repeater-UE link (the access link) simultaneously.

### NCR Forwarding Overview

FIG. 6 shows an example of communication between the base station 5 and a UE 3F via the NCR 9.

As shown in FIG. 6, in this example the base station 5 transmit signals in a plurality of beam directions 70a-70g. Each beam 70a-70g may have (but need not necessarily have) a corresponding index for identifying the beam. Alternatively, an index of a source reference signal (RS) may be used to indicate a beam (e.g. a TCI-like indicator). For Synchronization Signal Block (SSB) transmissions, the index may be an SSB index. In the example shown in FIG. 6, beams 70a to 70d are transmitted by the base station 5 in different beam directions using different time resources to achieve a beam sweeping effect. Whilst each beam 70a-70d is transmitted in a generally different direction, it will be appreciated that there may be some spatial overlap between the beams, as illustrated in FIG. 6 in which, for example, beam 70b partially overlaps beams 70a and 70c). For SIB1/S1/paging transmission, there may be one or multiple beam sweeping cycles within a SIB1/S1/paging transmission window/transmission occasion. In this example, the base station 5 also transmits beams 70e to 70g which are beamformed towards the NCR 9, for subsequent forwarding by the NCR 9 as the corresponding beams 70e-1 to 70g-1. However, a beam transmitted by the base station 5 for forwarding by the NCR 9 need not necessarily be beamformed towards the NCR 9.

The beamformed transmission illustrated in FIG. 6 may be, for example, SSB transmissions. SSB beams may be transmitted in the time domain as a group of SSB transmissions, which may be referred to as an ‘SSB burst set’. Each SSB in the SSB burst set may be referred to as an ‘SSB block’. For example, a 5 ms SSB burst set in which SSB beams 70a to 70d are transmitted by the base station 5 sequentially within a 5 ms time period may be used, resulting in the ‘beam sweeping’ effect. However, the burst set need not necessarily be of 5 ms duration. Various other transmission configurations in the time domain may be used depending on the configuration of the base station 5 and the available communication resources. Moreover, whilst in the example shown in FIG. 6 the base station 5 transmits four SSB, the number of SSB need not necessarily be four. The number of SSB could alternatively be less than or equal to 3, or greater than or equal to 5 (for example, up to 64 SSB blocks within an SSB burst set).

In the example of FIG. 6, a first UE 3E is located within the coverage area of SSB 70c transmitted by the base station 5. A second UE 3F is located within the coverage area of SSB 70f-1 transmitted by the NCR 9, and can communicate with the base station 5 via the NCR 9, by communicating with the NCR 9 over the access link (and by virtue of communication between the NCR 9 and the base station 5 via the backhaul link).

The first UE 3E receives the signal corresponding to SSB 70c, and may also receive signals corresponding to the other SSB (e.g. the neighbouring SSB 70b and 70d). The UE 3E and the base station 5 may perform an initial access procedure after the UE 3E has received one of the beamformed signals transmitted by the base station 5, and the UE 3E may be configured to transmit a corresponding measurement report to the base station 5. The UE 3E may perform measurements of, for example, syncronisation signal RSRP (SS-RSRP) or physical broadcast channel demodulation reference signal (PBCH DMRS). The UE 3E may be configured to determine an SSB index corresponding to a beam by decoding the PBCH DMRS. The UE 3E may determine a particular beam (and/or corresponding time or frequency resource) to be used for communication with the base station 5 based on corresponding signal measurements performed by the UE 3E. Alternatively, the UE 3E may report the measurements to the base station 5, and the base station 5 may determine the beam (and/or corresponding time or frequency resource) to be used for communication with the UE 3E.

In this example, the second UE 3F is not within the coverage area of a beam transmitted directly by the base station 5, because the UE 3F is located outside of the unextended range of the base station 5. However, the second UE 3F is within the coverage area of beam 70f-1 transmitted by the NCR 9. In other words, the second UE 3F is within an area of extended coverage provided by the NCR 9.

The NCR 9 receives the signals corresponding to the beams 70e-70g transmitted by the base station 5. The NCR-MT 201 determines the receive time windows corresponding to the beams (e.g. the receive time windows for S1, SIB1, and/or paging).

The NCR-MT 201 determines how and when to forward beamformed signal via the access link to the UE 3. In other words, the NCR-MT 201 determines the spatial, frequency and time resources to use to transmit one or more forwarded beams. The determination of how and when to forward the beams may be based on the side control information received from the base station 5 via the control link.

### NCR Procedure Overview

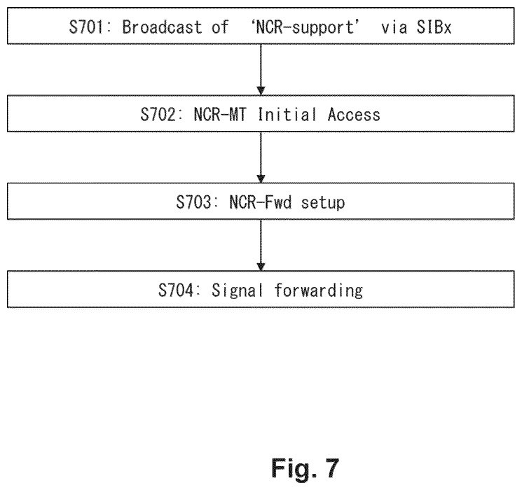

An overview of an exemplary NCR procedure will now be described with reference to FIG. 7.

In step S701, the base station 5 broadcasts ‘NCR-support’ via system information block x (SIBx). For example, the base station 5 may broadcast NCR-support via SIB1. In this example, the information element (IE) type of NCR-support is ‘true’. For the case of multiple Public Land Mobile Networks (PLMNs) indicated in SIB1, this field is common for all PLMNs.

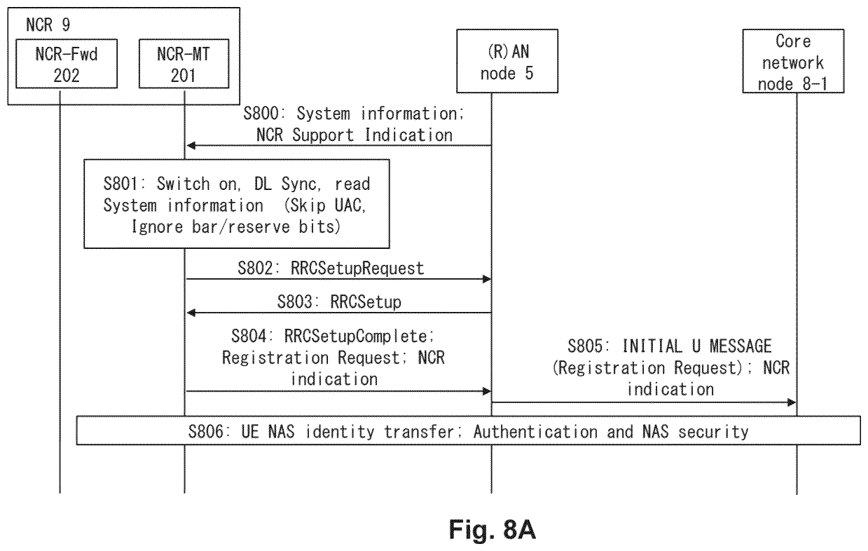

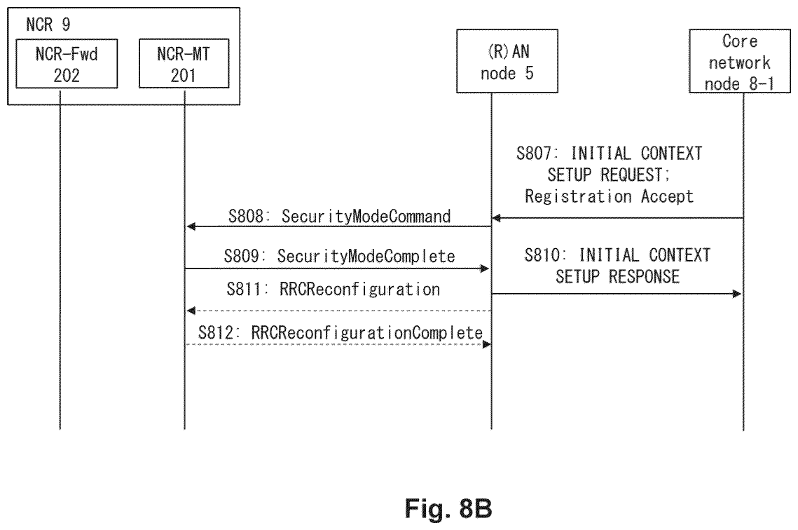

In step S702, an NCR-MT initial access step is performed. At this stage of the procedure, the access link between the NCR 9 the UE 3 is not ready for the forwarding of data. The NCR-MT 201 starts a registration/attach procedure in the cell that broadcasts ‘NCR-support’=‘true’. For NCR-MT 201, cellBarred, cellReservedForOperatorUse and cellReservedForOtherUse are ignored, and unified access control (UAC) is skipped. The NCR-MT initial access procedure will be described in more detail below with reference to FIGS. 8A and 8B.

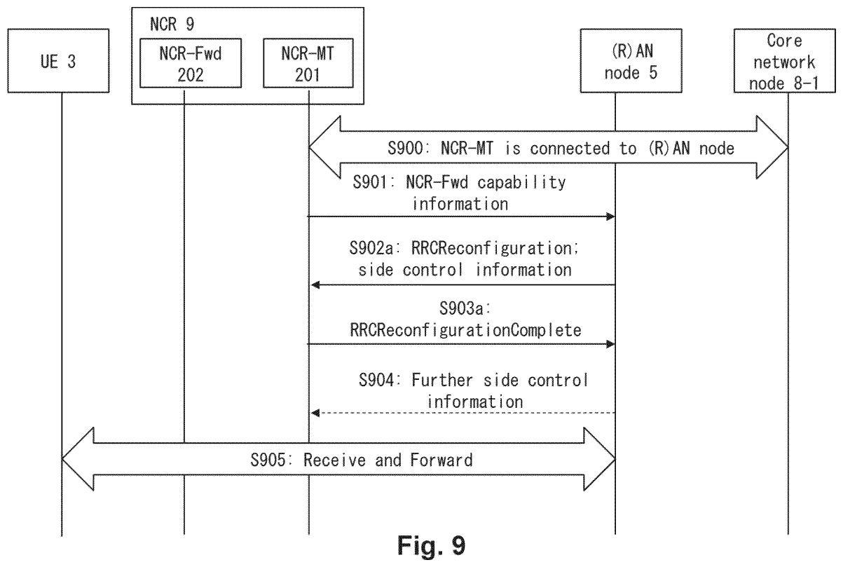

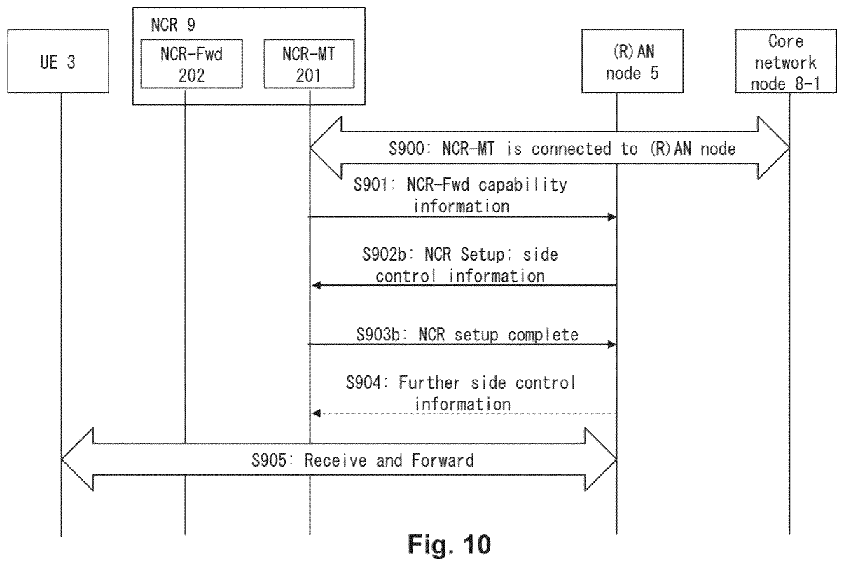

In step S703, an NCR-Fwd setup step is performed. As will be described below with reference to FIGS. 9 and 10, the method may comprise reusing RRCConnectionReconfiguration, or may alternatively use a new ‘NCR setup’ procedure for NCR-Fwd 202 initialisation. Initial side control information may be transmitted that includes one or both of: a list of SSB-Index for repeater coverage; or Initial on-off of Fwd and corresponding beam forming information at different time windows. NCR-Fwd 202 is activated after the NCR-Fwd setup phase is completed. NCR-Fwd 202 may be activated upon ‘reconfiguration complete’, or ‘NCR setup complete’.

In step S704, a signal forwarding step is performed in which the NCR 9 receives signals from the base station 5, and transmits corresponds signals to a UE 3. The NCR 9 may receive further side control information from the base station 5 for control of the NCR-Fwd access link (or for control of the backhaul or control link between the NCR 9 and the base station 5).

### NCR-MT Initial Access Procedure

An NCR-MT Initial Access procedure (e.g. for use as the NCR-MT Initial Access procedure in step S702 of FIG. 7) will now be described with reference to FIGS. 8A and 8B.

The procedure illustrated in FIGS. 8A and 8B is based on the initial access and initial attach procedure between a UE 3 and a base station 5 (see for example 3GPP TS 38.331 v17.1.0), but in this example is modified to include an indication of NCR support in the system information transmitted by the base station 5, and an NCR indication from the NCR 7.

Referring firstly to FIG. 8A, in step S800 the base station 5 transmits system information to the NCR-MT 201. Advantageously, the system information includes an NCR support indication, enabling the NCR-MT 201 to determine whether the base station 5 supports NCR 9. The base station 5 may broadcast ‘NCR-support’ via an appropriate system information block (SIB). For example, the base station 5 may broadcast an NCR support indication (e.g., an ‘NCR-support’ information element (IE)) via SIB1. In this example, the NCR-support is set to ‘true’, indicating that NCR 9 is supported (or a specific functionality of the NCR is supported) by the base station 5 (alternatively, NCR-support may be ‘false’, indicating that NCR 9 is not supported by the base station 5, or the NCR-support indication may be omitted entirely), although it will be appreciated that any suitable indication (explicit or implicit) of NCR support may be used. For the case of multiple Public Land Mobile Network (PLMN) indicated in SIB1, this field is common for all PLMN.

In step S801, switch on, downlink (DL) syncronisation, and reading of the system information received from the base station 5 is performed. Unified access control (UAC) is skipped, and bar/reserve bits (e.g., bits indicating access/cell barring and/or cell reservation) are ignored.

In step S802, an RRC setup request message is transmitted from the NCR-MT 201 to the base station 5.

In step S803, an RRC setup message is transmitted from the base station 5 to the NCR-MT 201.

In step S804, an RRC setup complete message including a registration request is transmitted to the base station 5. In this example, the RRC setup complete message includes an NCR indication. Advantageously, the NCR indication is used by the NCR 9 to indicate, to the base station 5, that it is an NCR. However, the NCR indication need not necessarily be included.

In step S805, an INITIAL UE MESSAGE is transmitted from the base station 5 to the core network node 8-1 (for example, AMF). The base station 5 may also transmit the registration request and the NCR indication to the core network node 8-1.

In step S806, UE NAS identity transfer, Authentication and NAS security processing is performed.

Referring now to FIG. 8B, in step S807 the core network node 8-1 transmits INITIAL CONTEXT SETUP REQUEST and registration accept to the base station 5.

In step S808 the base station 5 transmits a security mode command to the NCR-MT 201.

In step S809, the NCR-MT 201 transmits a security mode complete to the base station 5.

In step S810, the base station 5 transmits INITIAL CONTEXT SETUP RESPONSE to the core network node 8-1.

In optional step S811, the base station 5 transmits an RRC reconfiguration message to the NCR-MT 201.

In optional step S812, the NCR-MT 201 transmits RRC reconfiguration complete to the base station 5.

During the registration/attach, there are two options for identifying the NCR-MT type to the base station 5. In the first option, the NCR-MT 201 sets the content of the RRC setup complete message with the NCR node indication (e.g., as described above). In the second option, the NCR-MT 201 compiles and transfers the NCR node indication associated with its radio UE capability information, for example, upon receiving a UE capability enquiry from the base station 5.

For protocol data unit (PDU) session configuration, data radio bearer (DRB) configuration and the Core network-Base station interface (for example, Ng interface) there are two options. In the first option (which may be referred to as the legacy option), the Core network-Base station interface is established and the PDU session and default DRB/SRB2 are set up. In the second option, the base station 5 stores the UE context, but without the Core network-Base station connection and without the PDU session configuration or DRB configuration. In the second option, signalling radio bearer 2 (SRB2) may also not be needed.

### NCR-Fwd Setup Procedure

An NCR-Fwd setup procedure (e.g. for use as the NCR-Fwd setup procedure in step S703 of FIG. 7) will now be described with reference to FIG. 9.

In the NCR-Fwd setup procedure, the use of RRC signalling for the transmission of the side control information is advantageous, since this information is semi-persistent/static, and is relevant to always-on/common channels of a cell. At least some of the RRC side control information may be indicated implicitly, for example, by a list of SSB indices. Alternatively, or additionally, at least some of the RRC side control information may be indicated explicitly, for example by indicating one or more of an index, a timing information field, and/or a beam information field. The index may be included in signalling for further updates to the configuration (e.g. updating the beam information due to UE movement, and either maintaining the same time/frequency information or releasing the configuration). The timing (frequency) information field may indicate a time at which the NCR 9 is to relay a signal between the base station 5 and the UE 3. The timing information may correspond to a repeatable pattern. The beam information field may indicate a beam direction to be used for transmission/reception on the access link. The beam direction information can be used in combination with a time/frequency indicated by the timing information field.

In step S900, the NCR-MT is connected to the base station 5 after finishing an NCR-MT Initial Access Procedure (e.g. the procedure illustrated in in FIG. 8).

In this example, in step S901, the NCR-MT 201 transmits NCR-Fwd capability information to the base station 5. The NCR-Fwd may indicate a number of SSB (e.g. a number of SSB supported by the NCR 9), and/or antenna information of the NCR 9. Beneficially, the base station 5 is able to more efficiently and effectively configure the NCR 9 based on the received NCR-Fwd capability information. Examples of information that may be included in the NCR-Fwd capability information are described in more detail later.

In step S902a, the base station 5 transmits an RRC reconfiguration message including side control information to the NCR-MT 201.

In step S903a, the NCR-MT 201 transmits a RRCReconfigurationComplete message to the base station 5.

In optional step S904, the base station 5 may transmit further side control information to the NCR-MT 201.

In step S905, a receive and forward procedure is performed. In the receive and forward procedure, the NCR 9 receives transmissions from the base station 5 on the backhaul link and forwards the transmissions to the UE 3 on the access link. Similarly, the NCR 9 receives transmissions from the UE 3 on the access link and forwards the transmissions to the base station 5 via the backhaul link. In step S905 the NCR 9 may, for example, receive and forward downlink SSBs (e.g. SSB #a/b/c), SIB1, system information (S1) and/or paging information during paging occasions (POs) on the downlink. On the uplink, the NCR 9 may receive and forward uplink information during POs corresponding to the SSB (e.g. SSB #a/b/c).

An alternative NCR-Fwd setup procedure is shown in FIG. 10. In the example of FIG. 10, steps S902a and S903a are replaced with steps S902b and S903b. The remaining steps shown in FIG. 10 are the same as the corresponding steps shown in FIG. 9.

In step S902b, the base station 5 transmits a new NCR Setup message comprising side control information to the NCR-MT 201, for initialisation of the NCR-Fwd 202.

In step S903b, the NCR-MT transmits an NCR setup complete message to the base station 5, indicating that the initialisation of the NCR-Fwd 202 is complete. Advantageously, therefore, by exchanging the new NCR Setup and NCR setup complete messages, the base station 5 and NCR 9 are able to more efficiently exchange information regarding the NCR 9.

In the examples shown in FIGS. 9 and 10 the signalling 902a/b and 903a/b may be, for example, for indicating time information, frequency information, spatial (beamforming) information, power control information, interference management information, or frame structure information for the transmissions that are to be received and/or transmitted by the NCR 9. For example, the signalling 902a/b may include access link configuration information, backhaul link configuration information and/or control link configuration.

After completion of the NCR-Fwd set up procedure, relaying of signals by the NCR-Fwd begins, to provide the area of extended coverage. In the examples illustrated in FIGS. 9 and 10, NCR-Fwd relaying is activated after the reception of the RRC Reconfiguration Complete or NCR setup complete message at the base station 5, respectively.

### Side Control Information Addition/Update/Release Procedure

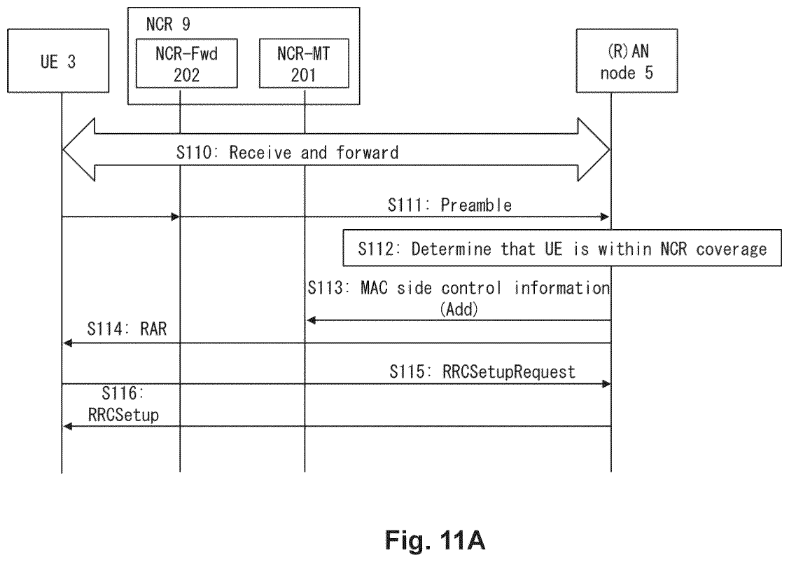

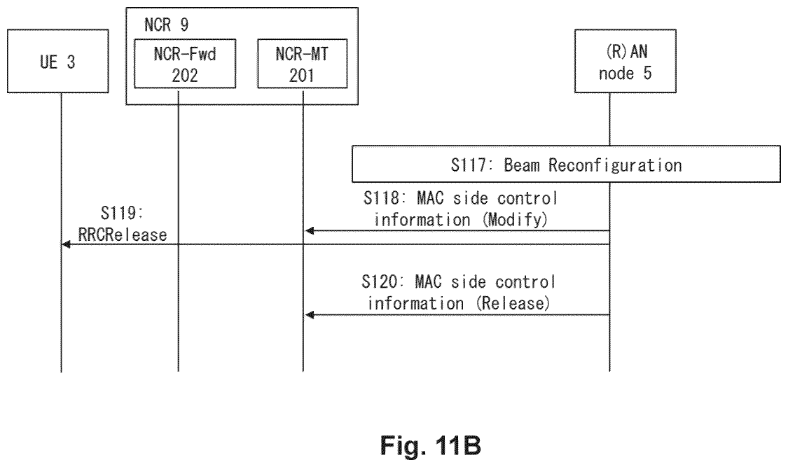

A side control information update procedure related to UE 3 access/release via the NCR 9 will now be described with reference to FIGS. 11A and 11B.

In the method shown in FIGS. 11A and 11B, side control information is transmitted to configure the timing at which the NCR-Fwd is to relay a signal, and to provide an indication of a direction (beamforming information) in which to relay or to receive in the uplink. For example, the beamforming information may indicate a direction that corresponds to the location of a particular UE 3.

In this example, medium access control (MAC) signalling is used for the transmission of the side control information. MAC signalling is advantageous because the side control information is exchanged relatively frequently, it is relevant to scheduling and beamforming, and the number of bits of side control information is not too small. However, MAC signalling need not necessarily be used for the transmission of the side control information.

The MAC Control Element (MAC CE) may comprise an index that indicates further updates to the configuration. For example, updating the beam information due to UE movement while maintaining the same time/frequency information, or releasing the configuration. The timing (frequency) information field may indicate a time at which the NCR 9 is to relay the signal between the base station 5 and the UE 3. The timing information may correspond to a repeatable or periodic pattern. The timing information may correspond to downlink (DL) or uplink (UL) subframes, slots and/or symbols. The beam information field may indicate a beam direction to be used for transmission/reception on the access link. The beam direction information can be used in combination with a time/frequency indicated by the timing information field.

Referring now to FIG. 11A, in step S110 a receive and forward procedure is performed by NCR-Fwd 202 based on previously received side control information. As described above, in the receive and forward procedure the NCR 9 receives transmissions from the base station 5 on the backhaul link and forwards the transmissions to the UE 3 on the access link. Similarly, the NCR 9 receives transmissions from the UE 3 on the access link and forwards the transmissions to the base station 5 via the backhaul link. For example, the receive and forward procedure may receive and forward downlink SSBs (e.g. SSB #a/b/c), SIB1, system information (S1) and/or paging information during paging occasions (POs) on the downlink. On the uplink, the NCR 9 may receive and forward uplink information during POs corresponding to the SSB (e.g. SSB #a/b/c).

In step S111, a preamble is transmitted from the UE 3 to the base station 5, via the NCR-Fwd 202.

In this example, in step S112 the base station 5 determines (e.g., based on the preamble) that the UE 3 is located with the coverage area of the NCR 9.

In step S113, the base station 5 transmits MAC side control information (Add) to the NCR-MT 201 to indicate an additional time at which the NCR 9 is to relay a signal in the uplink and/or downlink. For the downlink relay, the MAC side control information may indicate a beam direction in which NCR-Fwd 202 is to relay a received signal at the aforementioned additional time. For uplink relay, the MAC side control information may indicate a beam direction in which the NCR-Fwd 202 is to receive a signal at the aforementioned additional time, for forwarding to the base station 5.

In step S114 the base station 5 transmits a random access response (RAR) to the UE 3 via the NCR 9.

In step S115, the UE 3 transmits an RRC Setup Request to the base station 5.

In step S116, the base station 5 transmits an RRC Setup message to the UE 3.

Referring now to FIG. 11B, in step S117 the base station 5 performs the Beam Reconfiguration procedure. The UE beam is reconfigured based on a measurement configuration/report.

In step S118 the base station 5 transmits MAC side control information (Modify) to the NCR-MT 201 (e.g. to modify a beam direction or any other configuration or parameter configured in step S113 for one or more control, backhaul or access links).

In step S119 the base station 5 transmits an RRCRelease message to the UE 3 via the NCR 9.

In step S120 the base station 5 transmits a MAC side control information (Release) message to the NCR-MT 201 to release e.g., the side control information configured in steps S113 and S118.

It should be noted that steps S113, S118 and S120 may be performed at any time during the NCR data forwarding stage, and the above described sequence of method steps is an example of when side control information reconfiguration/update may be triggered by UE access, moving and release.

### NCR Power Control Capability

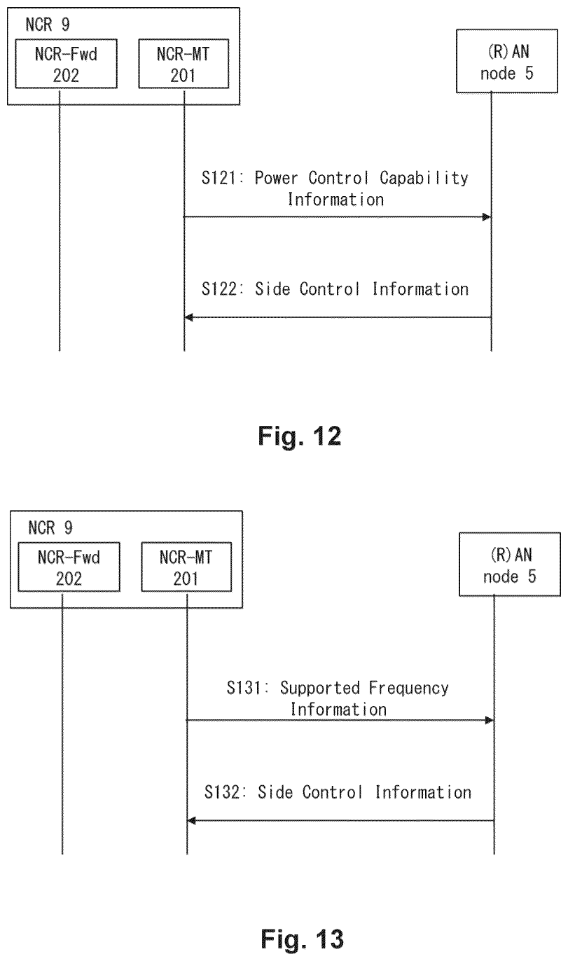

Power control capability information which may be transmitted, for example, as part of the NCR capability information transmitted in step S901 of FIG. 9, will now be described. The power control capability information is not limited to being transmitted in step S901 of FIG. 9, and could instead be transmitted from the NCR 9 to the base station 5 in any other suitable procedure (e.g. in the alternative method illustrated in FIG. 10). For example, as illustrated in step S121 of FIG. 12 the power control capability information may be transmitted separately to base station 5 at any suitable time, or as part of any suitable procedure (e.g. upon initial connection of the NCR 9 to the base station 5, or as part of an RRC information exchange procedure).

Advantageously, the transmission of power control capability information improves the overall performance and efficiency of the system 1. Nevertheless, since power control capability increases the complexity and cost of the NCR 9, the NCR 9 need not necessarily be configured for power control capability.

An NCR-MT 201 part of NCR capability information may comprise information that would be included in a UE 3 capability exchange. However, advantageously additional capability information may be defined for indicating the capability of the NCR 9 with respect to the access link between the NCR 9 and the UE 3.

The power control capability information transmitted from the NCR 9 to the base station 5 includes an indication of whether the NCR 9 supports power control or gain control for the access link. Additionally, or alternatively, the power control capability information indicates whether the NCR 9 supports power control or gain control for the backhaul link. Additionally, or alternatively, the power control capability information indicates whether the NCR 9 supports power control or gain control for the NCR-Fwd 202. If power control is not supported by the NCR 9, then a fixed NCR gain value may be indicated in the power control capability information.

If power control or gain control is supported, then the power control capability information may include power/gain control values supported by the NCR 9. For example, the power control capability information may include a range of gain values, a minimum gain value, and/or a maximum gain value supported by the NCR 9.

The power control capability information may be included in a MAC CE or DCI that is included in a transmission from the NCR 9 to the base station 5. The MAC CE or DCI may include an indication of a current power/gain control state of the NCR 9. For example, the MAC CE or DCI may include an indication of a current gain value, or an indication of a gain increase/decrease that could be performed. The transmission to the base station 5 that includes the MAC CE or DCI may be triggered by the base station 5, or alternatively may be based on a timer (e.g. transmitted periodically).

The power control information may be provided separately for each transmission direction (UL and DL), or alternatively may be common for both transmission directions.

Advantageously, the base station 5 is able to determine the power control capability of the NCR 9 based on the received power control capability information, enabling improved control the NCR 9 by the base station 5. For example, as illustrated in step S122 of FIG. 12, the base station 5 may transmit, based on the power control capability information received at the base station 5, side control information to the NCR 9 to control the operation of the NCR 9. This increases the overall efficiency of the system and reduces the risk of interference.

### Frequency Band Support

The radio configuration (e.g. supported frequency band) for the control link may be different from the radio configuration for the backhaul link or the access link (or the NCR-Fwd 202). The frequencies supported for the backhaul link and the access link (or the NCR-Fwd 202) may be significantly higher than the frequencies supported for the control link. For example, the backhaul link and the access link may support a 1 GHz continuous bandwidth, while the control link may support only a 5 MHz cell bandwidth. FIG. 13 illustrates the transmission of supported frequency information from the NCR 9 to the base station 5 in step S131. The supported frequency information includes an indication of the frequency bands and bandwidth supported for the backhaul link and/or the access link (or the NCR-Fwd 202). The supported frequency information may also include an indication of the frequency bands and bandwidth supported for the control link. Advantageously, the base station 5 is able to determine the frequencies supported by the NCR 9 for each communication link based on the supported frequency information, and is therefore able to perform improved control of the NCR 9 (e.g. more efficient scheduling of frequency resources).

The supported frequency information may be transmitted, for example, as part of the NCR capability information transmitted in step S901 of FIG. 9. However, the supported frequency information is not limited to being transmitted in step S901 of FIG. 9, and could instead be transmitted from the NCR 9 to the base station 5 in any other suitable procedure (e.g. in the alternative method illustrated in FIG. 10). For example, as illustrated in step S131 of FIG. 13 the supported frequency information may be transmitted separately to base station 5 at any suitable time, or as part of any suitable procedure (e.g. upon initial connection of the NCR 9 to the base station 5, or as part of an RRC information exchange procedure).

In step S132 the base station 5 transmits side control information to the NCR 9, to control the operation of the NCR 9 based on the supported frequency information received at the base station 5 from the NCR 9.

The supported frequency information may include an indication of frequency ranges for which independent operation of the backhaul link and the access link may be performed. For example, the supported frequency information may include an indication of frequency ranges supported with different TDD configurations.

The supported frequency information may include an indication of frequency ranges or bands supported by the NCR 9 for the backhaul link and/or the access link (and/or the NCR-Fwd 202).

The supported frequency information may include a bandwidth supported for each frequency range/band. For example, the frequency information may indicate that the NCR 9 can support 100 MHz NCR-FWD/backhaul link/access link bandwidth for a 2.4 GHz frequency channel and support 400 MHz NCR-FWD/backhaul link/access link bandwidth for a 28 GHz frequency channel.

The supported frequency information may be encoded in a manner similar to a carrier aggregation (CA) band combination capability, or could be indicated in a new information element.

The operation of the backhaul link and/or the access link may be controlled by the base station 5 based on a cell configuration or bandwidth configuration. For example, communication on the backhaul/access link may be performed over the entire bandwidth of the cell or bandwidth part (BWP) indicated. For the control link, individual channel configurations (for example, for PDCCH, Channel State Information Reference Signal (CSI-RS), sounding reference signal (SRS), PUCCH) may be provided, with the frequencies being restricted to those supported by the NCR-MT 201. One bandwidth part may be configured for the control link, whilst the backhaul/access link may operate using the entire cell bandwidth, or using another configured bandwidth part.

### Beamforming Support

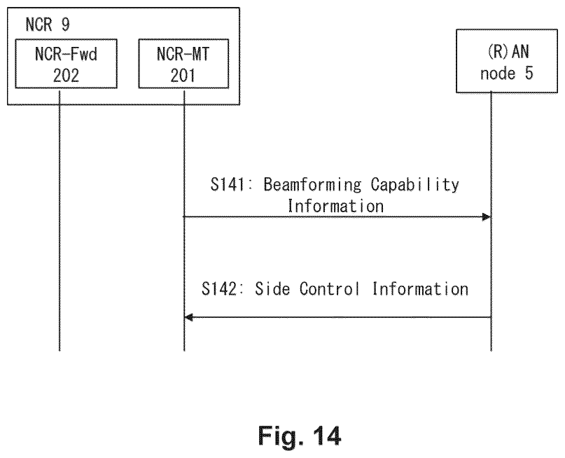

Antenna configurations for the NCR-base station link (for the backhaul link and the control link) may be different from antenna configurations for the access link between the NCR 9 and the UE 3. FIG. 14 illustrates the transmission of beamforming capability information from the NCR 9 to the base station 5 in step S141. The beamforming capability information (which may alternatively be referred to as antenna configuration information, or transmission capability information) includes an indication of an antenna configuration or beam configuration supported by the NCR 9 for the access link or NCR-Fwd 202. Advantageously, therefore, the base station 5 is able to determine the antenna configurations or beam configurations supported by the NCR 9 and is able to more effectively manage the beams.

The beamforming capability information may be transmitted, for example, as part of the NCR capability information transmitted in step S901 of FIG. 9. However, the beamforming capability information is not limited to being transmitted in step S901 of FIG. 9, and could instead be transmitted from the NCR 9 to the base station 5 in any other suitable procedure (e.g. in the alternative method illustrated in FIG. 10). For example, as illustrated in step S141 of FIG. 14 the beamforming capability information may be transmitted separately to base station 5 at any suitable time, or as part of any suitable procedure (e.g. upon initial connection of the NCR 9 to the base station 5, or as part of an RRC information exchange procedure).

In step S142 the base station 5 transmits side control information to the NCR 9, to control the operation of the NCR 9 based on the beamforming capability information received at the base station 5 from the NCR 9.

The beamforming capability information may include an indication of a number of SSB beams supported by the NCR 9.

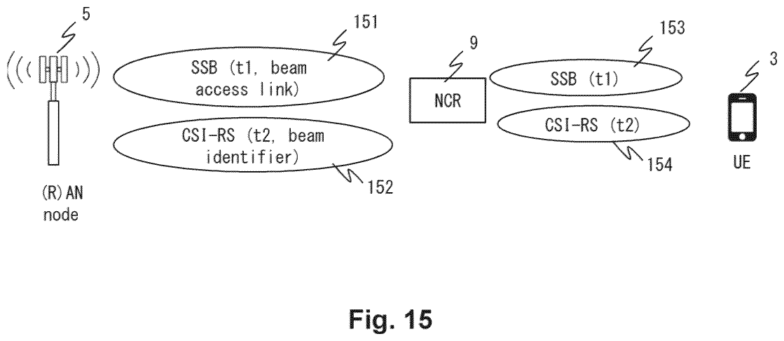

The beamforming capability information may include an indication of a number of beams supported by the NCR 9. The number of supported beams may be indicated per type of beam. For example, the beamforming capability information may include an indication of a number of supported wide beams and a number of supported narrow beams. As illustrated in FIG. 15, the transmissions between the base station 5 and the NCR 9 may include the transmission of SSB 151 at a time t1, and the transmission of CSI-RS 152 at a time t2 (corresponding transmissions 153, 154 are illustrated between the NCR 9 and the UE 3). The beamforming capability information may include an indication of a number of supported SSB beams and a number of supported CSI-RS or data beams. The beamforming capability information may also include an indication of the supported beam width for each of the supported beam types.

The beamforming capability information may include an indication of the supported beam widths and/or allowed beam sweeping ranges. For example, the beamforming capability information may include an indication of possible values (which may be discrete or continuous) of beam direction values.

The beamforming capability information may include an indication of a supported antenna configuration. The indication of the supported antenna configuration may include an indication of supported horizontal and/or vertical antenna elements, panels or ports. The supported antenna configuration may be provided per NCR 9, or alternatively could be provided per beam width or CSI-RS/SSB beam.

The beamforming capability information may be provided per frequency band. For example, if the NCR 9 supports two frequency bands with a relatively large difference (e.g. 5 GHz and 28 GHz), then the beamforming capability may be different for each of the frequency bands.

### PMI and Beamforming

For direct communication between a base station 5 and a UE 3, to enable precoding and Multiple-input/multiple-output (MIMO), different antenna ports are used for CSI-RS transmission in the same symbol so that the UE 3 can report back Precoding Matrix Indicator (PMI)/Channel Quality Information (CQI) by measuring each CSI-RS port independently. Beneficially, precoding enables the selection of a narrower beam for the Base station-UE link. In order to achieve this for the access link between the NCR 9 and the UE 3, the NCR should be able to transmit different CSI-RS sequences over different access link antenna ports. The NCR 9 could be configured to receive multiple CSI-RS sequences from the base station 5 at the same time occasion and map the CSI-RS sequences to different antenna ports for the access link. However, this would result in increased implementation complexity for the NCR 9. Moreover, MIMO is challenging to implement for the access link, because MIMO requires that the NCR 9 is configured to receive multiple transmission streams from the base station 5 and map them to appropriate antenna ports, which would also result in increased implementation complexity and cost for the NCR 9. The present inventors have realised that there is a need for a new procedure to enable the selection of a narrow beam for data transmission.

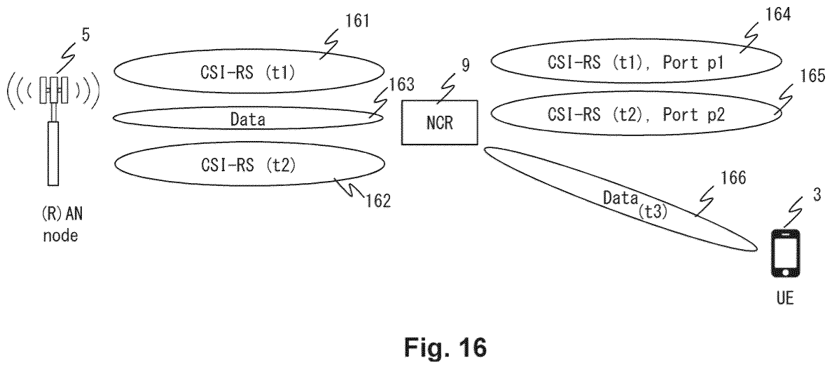

FIG. 16 shows an example in which a narrow beam is used for data transmission on the access link between the NCR 9 and the UE 3. As shown in the FIG. 16, the transmission between the base station 5 and the NCR 9 include a CSI-RS 161 transmitted at a time t1, and CSI-RS transmitted at a time t2, and a data beam 163 transmitted at a time t3. The transmissions from the NCR 9 include CSI-RS 164 at time t1 using a first port p1, CSI-RS 165 transmitted at time t2 using a second port p2, and a narrow beam 166 for data transmission to the UE 3 at a time t3 (later than t1 and t2). The data transmission to the UE 3 is performed using the first antenna port p1 which may have an associated first weight w1, and the second antenna port p2 which may have an associated weight w2. The first weight w1 and the second weight w2 are derived based on the UE measurement reports (e.g. PMI reporting) of CSI-RS 164 at time t1 using the first port p1 and CSI-RS 165 transmitted at time t2 using the second port p2.

In a first option, a PMI indication may not be supported for the access link (or the NCR-Fwd 202). In this case, the CSI-RS transmitted from the base station 5 to the NCR 9 contains a single port, and the CSI reporting does not include the rank indicator or PMI value.

In a second option, at least a wideband PMI indication is supported for the access link. To enable this, only CSI-RS configurations in which CSI-RS ports are transmitted in different symbols are used. The network may provide an indication of the mapping between the CSI-RS port/symbols and the corresponding antenna element/port of the NCR 9.

A CSI-RS configuration may be specified in which each CSI-RS port is mapped to a different time occasion. Alternatively, a CSI-RS configuration may be used in which a subset of the CSI-RS ports are disabled, such that the remaining enabled ports are mapped to different time occasions. In a further alternative, multiple TDM CSI-RS resources may be used, each TDM CSI-RS resource being mapped to a different CSI-RS port.

For CSI-reporting, only wideband PMI may be supported (e.g. no sub-band PMI), and the allowed rank indication may be single layer. It will be appreciated that this may be beneficial because sub-band PMI or multiple layer transmission can require complex baseband processing at the NCR 9 which may not be available.

In this example, the base station 5 transmits an indication of a beam to be used at the NCR 9 for transmission/reception (e.g. the data beam 166 of the access link). The base station 5 may transmit an indication of beam weight values to be used for corresponding antenna ports/elements at the NCR 9. Alternatively, the NCR 9 may provide information (e.g. included in the beamforming capability information described above with reference to FIG. 14) regarding oversampled beams (a number of beams that are spatially overlapping), and corresponding transmission/reception direction information. Advantageously, the base station 5 is then able to select one of the beams to be used for data transmission/reception (e.g. to provide the narrow data beam 166 illustrated in FIG. 16).

### Frame Structure Indication

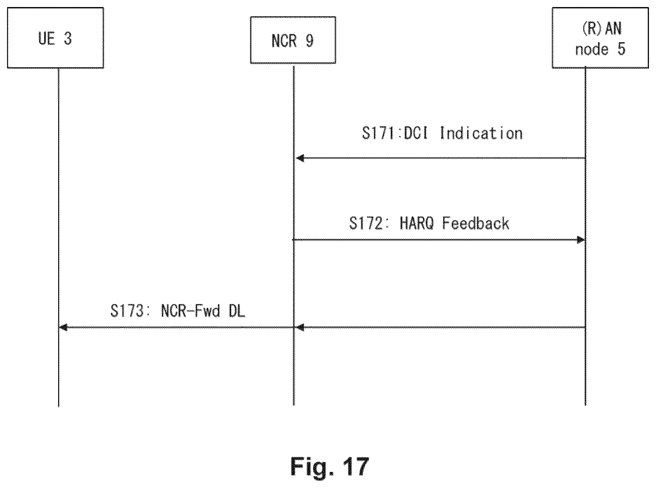

Frame structure information, for the backhaul link or the access link (or the NCR-Fwd 202), that can be exchanged between the base station 5 and the NCR 9 will now be described with reference to FIG. 17, which shows an example of DCI and Hybrid Automatic Repeat Request (HARQ) feedback exchanged between the base station 5 and the NCR 9.

The base station 5 may configure a semi static TDD configuration for the NCR 9. When a specific slot/symbol is to be switched on or off, then dynamic signalling can be used.

As shown in FIG. 17, the base station 5 may transmit DCI to the NCR 9. A DCI ‘on’ indication may be used to modify existing slot or symbol information. For example, the DCI may be for changing a beam configuration, power configuration or a transmission direction. A DCI ‘off’ indication may be used to indicate that backhaul link or access link transmissions are not to be performed by the NCR at a particular time.

The DCI on indication and the DCI off indication may have the same DCI format. The type of DCI information (on or off) may be indicated using an explicit DCI field that indicates whether the DCI corresponds to a DCI on indication or a DCI off indication. Alternatively, the type of DCI may be implicitly indicated using an invalid or reserved value for a DCI field (for example, by having an invalid value for a beam or frequency in the DCI). Alternatively, the NCR 9 may be configured to monitor for the two DCI formats. The base station 5 may transmit, to the NCR 9, an indication of the DCis that are to be activated and monitored by the NCR 9.

The DCI off indication may include time occasion information. For example, the DCI off indication may include slot and symbol information and time duration information. Multiple time occasions may be indicated by the DCI off indication.

The DCI on indication may also include time occasion information. For example, the DCI on indication may include slot and symbol information and time duration information. As for the DCI off indication, the DCI on indication may indicate multiple time occasions. For each of the time occasions indicated by the DCI on indication, the DCI on indication may include corresponding information indicating a transmission direction, frequency resource information, beam information for the access link, a QCL state to be used for the backhaul link (which enables the NCR 9 to select a receiving beam direction for the backhaul link), and/or power control information for the backhaul/access link. The frequency resource information may comprise a carrier, bandwidth part or frequency band. The beam information for the access link may comprise a beam weight, SSB beam indication, CSI-RS beam indication, or any other suitable type of beam identifier. If the QCL state information is not included in the DCI, then the backhaul link receiving beam direction may be selected based on the same QCL as used for receiving DCI control information associated with backhaul reception, or may be configured using RRC signalling (e.g. based on a CORESET configuration, a set of physical resources and parameters used to carry PDCCH/DCI). In one example, the base station 5 may determine to include the power control information in the DCI if the NCR 9 includes an indication that the NCR 9 supports power control in a transmission to the base station 5 (e.g. in step S121 shown in FIG. 12).

The DCI in the transmission from the base station 5 to the NCR 9 is subject to errors. The present inventors have realised that there is a need for an improved method and apparatus for more reliable transmission of the DCI, to ensure that the frame structure is well coordinated between the base station 5 and the NCR 9. FIG. 17 shows an example in which the reliability of the transmission of the DCI is improved by providing HARQ feedback. In step S171, the DCI indication (described in more detail above) is transmitted from the base station 5 to the NCR 9. In step S172, the NCR 9 transmits HARQ Feedback to the base station 5. The HARQ feedback transmitted by the NCR 9 indicates whether the corresponding DCI was successfully received at the NCR 9. The HARQ feedback may comprise an acknowledgement (ACK) indication or a negative-acknowledgement (NACK) indication. However, the transmission of NACK may not be needed and may be implicit (in some cases, transmission of NACK may not be possible, for example when the NCR is unable to determine that DCI was transmitted). The resources used for the transmission of the HARQ feedback may be indicated by the DCI itself, or could alternatively be indicated (e.g. using an implicit indication) as part of an RRC configuration. The actual time occasion of the NCR 9 ON/OFF may occur either earlier or later than the HARQ feedback.

The HARQ feedback corresponding to the DCI need not necessarily always be enabled. The HARQ feedback may be disabled for the DCI on indications and enabled for the DCI off indications. Alternatively, the HARQ feedback may be disabled for the DCI off indications and enabled for the DCI indications.

The HARQ feedback may be enabled/disabled based on HARQ control information transmitted from the base station 5 to the NCR 9. The HARQ control information may be common to both the DCI on indication and the DCI off indication, or alternatively separate HARQ control information may be provided for each type of DCI. The base station 5 may control the activation/deactivation of the HARQ feedback using RRC signalling, or the HARQ control information may be included in the DCI. The DCI may implicitly indicate whether HARQ feedback is to be enabled/disabled. For example, an invalid value may be set in the DCI (e.g. an invalid value for HARQ resources) to indicate that HARQ feedback is not required.

Whether HARQ feedback is to be used may be implicit based on the timing of an NCR ON/OFF occasion. For example, if the ON/OFF occasion occurs before the HARQ feedback occasion, or if the time difference between the DCI and the ON/OFF occasion is less than a threshold time difference, then the NCR 9 may determine that HARQ feedback is not required.

A MAC CE based mechanism may be used for the ACK/NACK feedback.

In step S173 the NCR 9 forwards a DL transmission from the base station 5 to the UE 3 based on the information included in the DCI indication (e.g. using an indicated beam configuration, power configuration and/or transmission direction for the backhaul and/or access link). Whilst in the example shown in FIG. 17 the forwarding by the NCR 9 in step S173 occurs after the transmission of the HARQ feedback in step S172, this need not necessarily be the case. Alternatively, step S173 may be performed before step S172.

Different transmission parameters may be used for the two types of DCI indications (on and off). For example, the DCI on indication may be configured to use a higher code rate or higher number of indications, to improve that probability of successful decoding.

The use of the DCI indication advantageously provides a mechanism for the base station 5 to control the behaviour of the NCR 9. However, there may be some time occasions for which the behaviour of the NCR 9 should not change over time (for example, SSB occasions). For some time occasions the base station 5 may transmit, to the NCR 9, an indication that the NCR 9 is to always perform forwarding. For some time occasions, the base station 5 may transmit, to the NCR 9, an indication that the NCR 9 is to never perform forwarding. The forwarding behaviour of the NCR 9 for time occasions (slot/symbol/periodicity) and the transmission directions (beamforming) may be explicitly configured by the base station 5. Alternatively, the configurations may be indicated implicitly. Alternatively, the configuration may be indicated based on a SSB, CSI-RS or physical random access channel (PRACH) configuration. For example, the base station 5 may indicate which SSB/CSI-RS/PRACH occasions are to be forwarded by the NCR 9, and associated beams, and/or shall indicate which SSB/CSI-RS/PRACH occasions are not to be forwarded by the NCR 9.

Some slots and/or symbols may be indicated as flexible (available for either UL or DL). For such slots/symbols, the NCR 9 may not perform forwarding unless indicated by the DCI indication.

Alternatively, the NCR 9 may perform a default operation (e.g. UL or DL forwarding) for the flexible slots/symbols that are not overridden by a DCI on/off indication. The default operation may be configured by the base station 5. Access link beam information may be configured by the base station 5, to be used for flexible symbols. Alternatively, the NCR 9 may use a default beam for the access link (e.g. the largest beam available for the access link).

In a further alternative, the base station 5 may configure forwarding per physical channel, for example CORESET, PUCCH, PRACH, SRS, or CSI-RS. Some of these resources might not be scheduled for the NCR-MT 201. For flexible symbols, the NCR-MT 201, the NCR-MT 201 determines whether DL or UL forwarding is to be performed based on whether the time occasion contains any of the DL or UL physical channel occasions.

### Uplink Conflicts

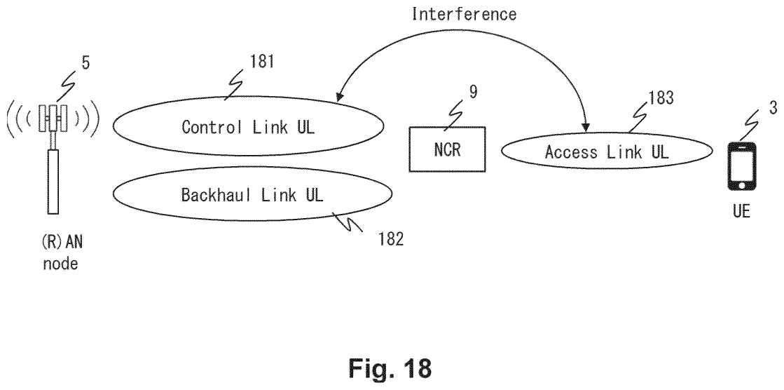

FIG. 18 shows an example of interference between the control link and the access link. As shown in the FIG. 18, interference may occur between the control link UL 181 and the access link UL 183. Interference between the backhaul link UL 182 and the access link UL 183 may be avoided by using TDM. However, there may be occasions when the NCR 9 may need to perform UL transmissions on the control link 181 whilst receiving UL transmissions on the access link from the UE. For example, the NCR 9 may need to perform UL control link transmissions for link recovery for PRACH, SRS for channel estimation by the base station 5, PUCCH for CQI reports or HARQ feedback, or PUSCH for RRC messages. The present inventors have realised that there is therefore a need for improved methods and apparatus for mitigating against interference that may occur between the control link UL 181 and the access link UL 183.

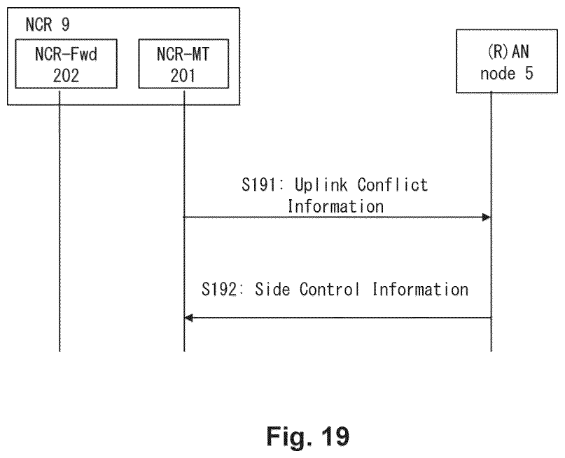

FIG. 19 shows a transmission for uplink conflict information from the NCR 9 to the base station 5 in step S191. The uplink conflict information may comprise an indication of whether the NCR 9 is able to perform simultaneous control link UL and access/backhaul link (or NCD-Fwd 202) UL at the same symbols. This capability may be associated with the frequency band/carrier used for the control link and for the access/backhaul link (or NCR-Fwd 202). For example, if the control link frequency band is different than that of the access/backhaul link frequency band, then simultaneous control link UL and access/backhaul UL may be possible.

If the uplink conflict information transmitted in step S191 includes an indication that simultaneous control link UL and access/backhaul link (or NCR-Fwd 202) UL is not supported (or not possible), then interference management may be performed for the carriers for which a conflict may occur. For example, during SRS/PUCCH occasions configured for NCR-MT 201, access link forwarding may not be performed by the NCR 9. In a further example, during time occasions for which PUSCH is scheduled for the NCR-MT 201, access link forwarding may not be performed. In a further example, access link forwarding may not be performed during RACH occasions when the NCR 9 is to performed RACH, or may be disabled when the NCR 9 initiates a RACH procedure (and may be restarted/enabled once the RACH procedure is complete/successful).

In step S192 the base station 5 transmits side control information to the NCR 9, to control the operation of the NCR 9 based on the uplink conflict information received at the base station 5 from the NCR 9 (e.g. to disable forwarding at a particular time, based on the uplink conflict information).

Whilst the example of interference illustrated in FIG. 18 is with respect to UL interference, it will be appreciated that a similar problem may occur for DL transmissions. For example, a similar conflict may occur between the control link DL and the access/backhaul link (or NCR-Fwd 202) DL. The NCR 9 may indicate to the base station 5 (e.g. in the uplink conflict information transmitted in step S191) whether the NCR supports simultaneous control link DL and access/backhaul link DL. As described above for the UL, this capability/support may be associated with the frequency band/carrier used for the control link and for the access/backhaul link. During a DL transmission occasion in which the NCR-MT 201 is to receive a DL transmission from the base station 5, DL forwarding may be disabled (on the backhaul/access links), thereby reducing the risk of interference. Access link DL may be disabled for PDCCH/CORESET resources configured for receiving control link information. Access link DL may be disabled for CSI-RS resources configured for the NCR-MT 201. Access link DL may be disabled for PDSCH transmission scheduled for NCR-MT 201.

The uplink conflict information may be transmitted, for example, as part of the NCR capability information transmitted in step S901 of FIG. 9. However, the uplink conflict information is not limited to being transmitted in step S901 of FIG. 9, and could instead be transmitted from the NCR 9 to the base station 5 in any other suitable procedure (e.g. in the alternative method illustrated in FIG. 10). For example, as illustrated in step S191 of FIG. 19, the power control capability information may be transmitted separately to base station 5 at any suitable time, or as part of any suitable procedure (e.g. upon initial connection of the NCR 9 to the base station 5, or as part of an RRC information exchange procedure).

### Modifications and Alternatives

Detailed example embodiments have been described above. As those skilled in the art will appreciate, a number of modifications and alternatives can be made to the above example embodiments whilst still benefiting from the disclosure embodied therein. By way of illustration only a number of these alternatives and modifications will now be described.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 and TS 37.340 V16.7.0 define the following nodes, amongst others:
gNB: node providing NR user plane and control plane protocol terminations towards the UE, and connected via the NG interface to the 5G core network (5GC).
ng-eNB: node providing E-UTRA user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

It will be appreciated that the above example embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

Each cell may have an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

In the above description, the UE 3, the access network node (base station 5) and the NCR 9 are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE 3, NCR 9 or base station 5 as a signal over a computer network, or on a recording medium. Further, the functionality performed by part or all of this software may be performed using one or more dedicated hardware circuits. However, the use of software modules is preferred as it facilitates the updating of the UE 3, NCR 9 or base station 5 in order to update their functionalities.

The above example embodiments are also applicable to ‘non-mobile’ or generally stationary user equipment 3. The above-described mobile device (UE) 3 may comprise an MTC/IoT device, a power saving UE, and/or the like.

The User Equipment 3 (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; (motor) vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & | Fleet Management |
| Tracing | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/ | Lighting |
| Control | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer | Digital photo frame |
| Devices | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VOLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary example embodiments described in the present document. Needless to say, these technical ideas and example embodiments are not limited to the above-described UE and various modifications can be made thereto.

Various other modifications will be apparent to those skilled in the art and will not be described in further detail here.

This application is based upon and claims the benefit of priority from United Kingdom Patent Application No. 2212692.4, filed on Aug. 31, 2022, the disclosure of which is incorporated herein in its entirety by reference.

For example, the whole or part of the exemplary example embodiments disclosed above can be described as, but not limited to, the following supplementary notes.

### (Supplementary Note 1)

A method for a network controlled repeater, NCR, the method comprising: transmitting, to an access network node, NCR capability information including at least one of:
power control capability information indicating a power control or gain control capability of the NCR;
supported frequency information indicating a frequency or frequency range supported by the NCR;
beamforming capability information indicating a beamforming capability of the NCR; or
an indication of a capability of the NCR to perform simultaneous uplink or downlink communication; and
receiving, from the access network node, control information for controlling the NCR, wherein the control information is based on the NCR capability information.

### (Supplementary Note 2)

The method according to Supplementary note 1, wherein the power control capability information comprises at least one of:
an indication of whether the NCR supports power control or gain control for transmissions by the NCR over an access link between the NCR and a user equipment, UE; or
an indication of whether the NCR supports power control or gain control for transmissions by the NCR over a backhaul link between the NCR and the access network node.

### (Supplementary Note 3)

The method according to Supplementary note 1 or 2, wherein in a case where a power control capability is not supported by the NCR, the power control capability information includes a gain value or power value that indicates that the power control capability or gain control capability is not supported.

### (Supplementary Note 4)

The method according to Supplementary note 1 or 2, wherein in a case where a power control capability is supported by the NCR, the power control capability information includes a power control or gain control parameter supported by the NCR.

### (Supplementary Note 5)

The method according to Supplementary note 4, wherein in a case where the power control capability is supported by the NCR, the power control capability information includes at least one of:
a range of gain or power values supported by the NCR; or
a maximum gain or power value supported by the NCR.

### (Supplementary Note 6)

The method according to any preceding Supplementary note, wherein the power control capability information includes an indication of a currently used power or gain used at the NCR.

### (Supplementary Note 7)

The method according to any preceding Supplementary note, wherein the power control capability information includes at least one of:
an indication of a power or gain increase that the NCR is capable of implementing;
an indication of a power or gain decrease that the NCR is capable of implementing.

### (Supplementary Note 8)

The method according to any preceding Supplementary note, wherein the method comprises transmitting the power control capability information to the access network node based on a timer, or in response to a transmission received from the access network node.

### (Supplementary Note 9)

The method according to any preceding Supplementary note, wherein the power control capability information includes an uplink indication that indicates a power control or gain control capability of the NCR for an uplink connection, and a downlink indication that indicates a power control or gain control capability of the NCR for a downlink connection.

### (Supplementary Note 10)

The method according to any one of Supplementary notes 1 to 8, wherein the power control capability information includes an indication of a power control or gain control capability of the NCR for both an uplink connection and a downlink connection.

### (Supplementary Note 11)

The method according to any preceding Supplementary note, wherein the supported frequency information comprises at least one of:
an indication of a frequency or frequency range supported by the NCR for an access link between the NCR and a user equipment, UE; or
an indication of a frequency or frequency range supported by the NCR for a backhaul link between the NCR and the access network node.

### (Supplementary Note 12)

The method according to Supplementary note 11,
wherein the supported frequency information includes an indication of a frequency or frequency range supported by the NCR for a control link between the NCR and the access network node; and
wherein the frequency or frequency range supported by the NCR for the control link is different from the frequency or frequency range supported by the NCR for the access link or the frequency or frequency range supported by the NCR for the backhaul link.

### (Supplementary Note 13)

The method according to Supplementary note 11 or 12, wherein the supported frequency information includes an indication of:
a first supported frequency or frequency range that is supported by the NCR, for the access link or the backhaul link with a first time division duplex, TDD, configuration; and
a second supported frequency or frequency range that is supported by the NCR, for the access link or the backhaul link, with a second TDD configuration;
wherein the first TDD configuration is different from the second TDD configuration.

### (Supplementary Note 14)

The method according to any preceding Supplementary note, wherein the supported frequency information includes an indication of a bandwidth corresponding to the frequency or frequency range supported by the NCR.

### (Supplementary Note 15)

The method according to any preceding Supplementary note, wherein the beamforming capability information includes an indication of an antenna configuration or a beam configuration supported by the NCR for transmission of a beamformed signal.

### (Supplementary Note 16)

The method according to Supplementary note 15, wherein the beamforming capability information includes an indication of at least one of:
horizontal or vertical antenna elements or ports supported by the NCR for transmission of a beamformed signal;
a panel supported by the NCR for transmission of a beamformed signal; or
a port supported by the NCR for transmission of a beamformed signal.

### (Supplementary Note 17)

The method according to Supplementary note 15 or 16, wherein the indication of the antenna configuration or the beam configuration supported by the NCR indicates an antenna configuration or a beam configuration supported by the NCR for an access link between the NCR and a UE, or for a backhaul link between the NCR and the access network node.

### (Supplementary Note 18)

The method according to any preceding Supplementary note, wherein the beamforming capability information includes an indication of a number of beam configurations supported by the NCR.

### (Supplementary Note 19)

The method according to any preceding Supplementary note, wherein the beamforming capability information includes an indication of a number of beams of a first beam type supported by the NCR, and an indication of a number of beams of a second beam type supported by the NCR.

### (Supplementary Note 20)

The method according to Supplementary note 19, wherein:
the first beam type corresponds to a wide beam and the second beam type corresponds to a narrow beam; or
the first beam type corresponds to a Synchronization Signal Block, SSB, beam and the second beam type corresponds to a Channel State Information Reference Signal, CSI-RS, beam or a data beam.

### (Supplementary Note 21)

The method according to any preceding Supplementary note, wherein the beamforming capability information includes an indication of a beam width of a beam supported by the NCR.

### (Supplementary Note 22)

The method according to any preceding Supplementary note, wherein the beamforming capability information includes an indication of at least one beam direction value supported by the NCR.

### (Supplementary Note 23)

The method according to any preceding Supplementary note, wherein the beamforming capability information includes an indication of a first beamforming capability of the NCR supported for a first frequency band, and an indication of a second beamforming capability of the NCR supported for a second frequency band.

### (Supplementary Note 24)

The method according to any preceding Supplementary note, wherein the indication of the capability of the NCR to perform simultaneous uplink or downlink communication indicates a capability of the NCR to perform simultaneous uplink or downlink communication for:
a control link between the NCR and the access network node; and
a backhaul link between the NCR and the access network node, or an access link between the NCR and a user equipment, UE.

### (Supplementary Note 25)

The method according to Supplementary note 24, wherein the indication of the capability of the NCR to perform simultaneous uplink or downlink communication indicates the capability of the NCR to perform simultaneous uplink or downlink communication for a particular frequency band or carrier.

### (Supplementary Note 26)

A method for a network controlled repeater, NCR, the method comprising:
receiving, from an access network node, an indication of a mapping between a port or symbol corresponding to a reference signal received from the access network node and a corresponding antenna element or port of the NCR; and
transmitting the reference signal based on the mapping.

### (Supplementary Note 27)

The method according to Supplementary note 26, wherein the method further comprises
receiving, from a user equipment, UE, measurement information corresponding a measurement of the reference signal by the UE;
transmitting the measurement information to the access network node; and
receiving, from the access network node, a beam indication that indicates a beam to be used for data transmission from the NCR to the UE.

### (Supplementary Note 28)

The method according to Supplementary note 27, wherein the beam indication includes one or more weight values to be used for an antenna port or antenna element of the NCR to be used for the data transmission from the NCR to the UE.

### (Supplementary Note 29)

A method for a network controlled repeater, NCR, the method comprising:
receiving, from an access network node, downlink control information for controlling transmission or reception at the NCR, and
transmitting feedback that indicates whether the downlink control information has been received at the NCR.
(Supplementary Note 30)

The method according to Supplementary note 29, wherein the feedback is Hybrid Automatic Repeat Request feedback.

### (Supplementary Note 31)

The method according to Supplementary note 29 or 30, wherein the downlink control information includes an indication of a beam configuration corresponding to the transmission or reception.

### (Supplementary Note 32)

The method according to any one of Supplementary notes 29 to 31, wherein the downlink control information includes an indication that the NCR is not to perform at least one of:
a transmission over a backhaul link between the NCR and the access network node; or
an access link between the NCR and a user equipment, UE.

### (Supplementary Note 33)

The method according to any one of Supplementary notes 29 to 32, wherein the downlink control information includes an indication of a resource for the transmission of the feedback.

### (Supplementary Note 34)

The method according to any one of Supplementary notes 29 to 33, wherein the method further comprises receiving, from the access network node, an indication of whether the transmission of the feedback is to be enabled or disabled.

### (Supplementary Note 35)

A method for an access network node, the method comprising:
receiving, from a network controlled repeater, NCR, NCR capability information including at least one of:
power control capability information indicating a power control or gain control capability of the NCR;
supported frequency information indicating a frequency or frequency range supported by the NCR;
beamforming capability information indicating a beamforming capability of the NCR; or
an indication of a capability of the NCR to perform simultaneous uplink or downlink communication; and
transmitting, to the NCR, control information for controlling the NCR, wherein the control information is based on the NCR capability information.

### (Supplementary Note 36)

A method for an access network node, the method comprising:
transmitting, to a network controlled repeater, NCR, an indication of a mapping between a port or symbol corresponding to a reference signal received from the access network node and a corresponding antenna element or port of the NCR; and
receiving the reference signal based on the mapping.

### (Supplementary Note 37)

A method for an access network node, the method comprising:
transmitting, to a network controlled repeater, NCR, downlink control information for controlling transmission or reception at the NCR, and
receiving feedback that indicates whether the downlink control information has been received at the NCR.

### (Supplementary Note 38)

A network controlled repeater, NCR, comprising:
means for transmitting, to an access network node, NCR capability information including at least one of:
   power control capability information indicating a power control or gain control capability of the NCR;
   supported frequency information indicating a frequency or frequency range supported by the NCR;
   beamforming capability information indicating a beamforming capability of the NCR; or
   an indication of a capability of the NCR to perform simultaneous uplink or downlink communication; and
means for receiving, from the access network node, control information for controlling the NCR, wherein the control information is based on the NCR capability information.

### (Supplementary Note 39)

A network controlled repeater, NCR, comprising:
means for receiving, from an access network node, an indication of a mapping between a port or symbol corresponding to a reference signal received from the access network node and a corresponding antenna element or port of the NCR; and
means for transmitting the reference signal based on the mapping.

### (Supplementary Note 40)

A network controlled repeater, NCR, comprising:
means for receiving, from an access network node, downlink control information for controlling transmission or reception at the NCR, and
means for transmitting feedback that indicates whether the downlink control information has been received at the NCR.

### (Supplementary Note 41)

An access network node comprising:
means for receiving, from a network controlled repeater, NCR, NCR capability information including at least one of:
   power control capability information indicating a power control or gain control capability of the NCR;
   supported frequency information indicating a frequency or frequency range supported by the NCR;
   beamforming capability information indicating a beamforming capability of the NCR; or
   an indication of a capability of the NCR to perform simultaneous uplink or downlink communication; and
means for transmitting, to the NCR, control information for controlling the NCR, wherein the control information is based on the NCR capability information.

### (Supplementary Note 42)

An access network node comprising:
means for transmitting, to a network controlled repeater, NCR, an indication of a mapping between a port or symbol corresponding to a reference signal received from the access network node and a corresponding antenna element or port of the NCR; and
means for receiving the reference signal based on the mapping.

### (Supplementary Note 43)

An access network node comprising:
means for transmitting, to a network controlled repeater, NCR, downlink control information for controlling transmission or reception at the NCR, and
means for receiving feedback that indicates whether the downlink control information has been received at the NCR.

### REFERENCE SIGNS LIST

1 mobile (cellular or wireless) telecommunication system
3 mobile device
5 base station/(R)AN node
6 associated cell
7 core network
9 network controlled repeater (NCR)
10 data network
21 transceiver circuit
22 antenna
23 controller
24 user interface
25 memory
26 operating system
27 communications control module
31 transceiver circuit
32 antenna
33 controller
34 memory
35 operating system
36 communications control module
37 control link module
38 amplification and forwarding module
41 transceiver circuit
42 antenna
43 network interface
44 controller
45 memory
46 operating system
47 communications control module
48 control link module
10) 49 backhaul module

What is claimed is:

1-40. (canceled)

41. A method for a network controlled repeater (NCR), the method comprising:
receiving, from an access network node, configuration information for a time resource for transmission or reception at the NCR;
receiving, from the access network node, downlink control information for controlling transmission or reception at the NCR, and
determining whether to modify configuration of the time resource based on the downlink control information.

42. The method according to claim 41, wherein
the downlink control information indicates a time occasion for which the configuration of the resource should change, and a time occasion for which the configuration of the resource should not change.

43. The method according to claim 41, further comprising:
in a case where the NCR cannot perform simultaneous uplink or downlink communication due to conflict among a control link between the NCR and the access network node and a backhaul link between the NCR and the access network node or an access link between the NCR and a user equipment (UE), stopping transmission via the access link and/or the backhaul link.

44. The method according to claim 41, further comprising:
in a case where a Quasi Co Location (QCL)-related parameter is not provided by the access network node, using a same QCL parameter as used for receiving downlink control information for receiving on a backhaul link between the NCR and the access network node.

45. The method according to claim 41, wherein
the downlink control information is used for dealing with interference among transmission of a control link between the NCR and the access network node, a backhaul link between the NCR and the access network node, and an access link between the NCR and a user equipment (UE).

46. The method according to claim 41, wherein
the downlink control information is used for configuring at least one beam used for transmission of a control link between the NCR and the access network node, a backhaul link between the NCR and the access network node, and an access link between the NCR and a user equipment (UE).

47. The method according to claim 41, wherein
the downlink control information is used for configuring mapping between a port or symbol corresponding to a reference signal received from the access network node and a corresponding antenna element or port of the NCR.

48. A method for an access network node, the method comprising:
transmitting, to a network controller repeater (NCR), configuration information for a time resource for transmission or reception at the NCR; and
transmitting, to the NCR, downlink control information for controlling transmission or reception at the NCR, wherein
the downlink control information is used by the NCR to determine whether to modify configuration of the time resource based on the downlink control information.

49. A network controlled repeater (NCR) comprising:
at least one memory configured to store instructions; and
at least one processor configured to execute the instructions to:
receive, from an access network node, configuration information for a time resource for transmission or reception at the NCR;
receive, from the access network node, downlink control information for controlling transmission or reception at the NCR, and
determine whether to modify configuration of the time resource based on the downlink control information.

50. The NCR according to claim 49, wherein
the downlink control information indicates a time occasion for which the configuration of the resource should change, and a time occasion for which the configuration of the resource should not change.

51. The NCR according to claim 49, wherein the at least one processor is configured to execute the instructions to:
in a case where the NCR cannot perform simultaneous uplink or downlink communication due to conflict among a control link between the NCR and the access network node and a backhaul link between the NCR and the access network node or an access link between the NCR and a user equipment (UE), stop transmission via the access link and/or the backhaul link.

52. The NCR according to claim 49, wherein the at least one processor is configured to execute the instructions to:
in a case where a Quasi Co Location (QCL)-related parameter is not provided by the access network node, use a same QCL parameter as used for receiving downlink control information for receiving on a backhaul link between the NCR and the access network node.

53. The NCR according to claim 49, wherein
the downlink control information is used for dealing with interference among transmission of a control link between the NCR and the access network node, a backhaul link between the NCR and the access network node, and an access link between the NCR and a user equipment (UE).

54. The NCR according to claim 49, wherein
the downlink control information is used for configuring at least one beam used for transmission of a control link between the NCR and the access network node, a backhaul link between the NCR and the access network node, and an access link between the NCR and a user equipment (UE).

55. The NCR according to claim 49, wherein
the downlink control information is used for configuring mapping between a port or symbol corresponding to a reference signal received from the access network node and a corresponding antenna element or port of the NCR.

56. An access network node comprising:
at least one memory configured to store instructions; and
at least one processor configured to execute the instructions to:
transmit, to a network controller repeater (NCR), configuration information for a time resource for transmission or reception at the NCR; and
transmit, to the NCR, downlink control information for controlling transmission or reception at the NCR, wherein
the downlink control information is used by the NCR to determine whether to modify configuration of the time resource based on the downlink control information.
